(19) United States
(12) Patent Application Publication
(10) Pub. No.: US 2025/0251611 A1
(43) Pub. Date: Aug. 7, 2025

(54) RECORDING MEDIUM, DISPLAY CONTROL DEVICE, AND DISPLAY CONTROL METHOD

(71) Applicant: KONAMI DIGITAL ENTERTAINMENT Co., LTD., Tokyo (JP)

(72) Inventor: Noriaki OKAMURA, Tokyo (JP)

(73) Assignee: KONAMI DIGITAL ENTERTAINMENT Co., LTD., Tokyo (JP)

(21) Appl. No.: 19/189,362

(22) Filed: Apr. 25, 2025

Related U.S. Application Data
(63) Continuation of application No. PCT/JP2023/038228, filed on Oct. 23, 2023.

(30) Foreign Application Priority Data
Oct. 23, 2023 (JP) 2022-188764

(51) Int. Cl. G02B 27/01

(52) U.S. Cl. CPC G02B 27/0179; G02B 27/0172; G02B 2027/0134; G02B 2027/0138; G02B 2027/0185

(57) ABSTRACT

A viewing direction specifying unit specifies a viewing direction as a direction of a user's line of sight for the VR space. An image generation unit generates the VR image according to the viewing direction by arranging in the VR space, a plurality of live-action images captured by a plurality of cameras having different imaging directions of imaging a real space so as to have an overlap area in which the respective viewing regions of the adjacent live-action images partially overlap with each other. Further, the image generation unit dynamically switches based on the viewing direction, the live-action image to be displayed in the overlap area between the adjacent live-action images.

### CROSS-REFERENCE TO RELATED APPLICATIONS

This application is a Continuation of International Application No. PCT/JP2023/038228, filed Oct. 23, 2023 in the Japanese Patent Office, which is based upon and claims the priority of the prior Japanese Patent Application No. 2022-188764, filed on Nov. 25, 2022, the entire contents of each of which being incorporated by reference herein.

### BACKGROUND ART

### Field of Invention

The present invention relates to a program, a display control device, an image display system, and a recording medium.

### Description of Related Art

Conventionally, a head-mounted display (HMD) that displays a stereoscopic virtual reality (VR) image using binocular parallax is known. This HMD can display a computer-generated VR space, a live-action image (still image or video) captured in a real space, and the like. In the case of a live-action image, for example, even by a single stereo camera or the like with a wide-angle lens, it is possible to capture a wide-angle image with a certain viewing angle. However, it becomes difficult to see the image stereoscopically in a direction far away from a viewing axis of the camera. In order to reduce this problem of the difficulty in stereoscopic visualization, there has been proposed the method of generating a wide viewing angle image by synthesizing and processing a plurality of images respectively captured in divided areas using a plurality of cameras (for example, Japanese Patent Application Laid-Open Publication No. 2011-227306).

Each of plural cameras has certain volume, and it is therefore physically impossible to arrange a plurality of cameras so that respective imaging centers are concentrated at one point. For this reason, in the images captured by the plurality of cameras, a misalignment occurs in a boundary region between adjacent images, which results in a visible seam (caused by a significant intensity difference of pixels, etc.). For this reason, when capturing images using a plurality of cameras in divided areas, it is necessary to perform a stitching process of combining images captured by respective cameras to finally create one piece of image data. This stitching process can be performed automatically using a dedicated software. However, in order to realize a more natural seamless image, it is necessary to manually perform this process that takes time. Here, a degree of misalignment between adjacent images depends on a distance between a camera and an object to be imaged, and the closer the object is to the camera, the larger the degree of misalignment is and the more difficult the stitching process becomes. In particular, when the distance between the camera and the object is less than a certain distance (for example, 2 m or less), the degree of misalignment becomes considerably large, and the stitching process becomes difficult. For this reason, with a conventional technique of combining a plurality of images captured by a plurality of cameras by stitching, it has been practically impossible to create a VR image including an object to be imaged at short distance (less than a certain distance from the camera) and to display the VR image on the HMD with small visual discomfort.

### SUMMARY

Therefore, one of the objects of the present invention is to realize a display control of a VR image with small visual discomfort when the VR image is displayed on an HMD using a plurality of images respectively captured by a plurality of cameras even if an object to be imaged at short distance is included.

A non-transitory computer readable storage medium in one aspect of the present invention having recorded therein a program that is executed by a processor of an information processing apparatus, the program causes the processor to display as a stereoscopic image to which binocular parallax is applied, a VR image of a field of vision from a virtual viewpoint in a virtual reality (VR) space on a display unit of a head mount display, specify a viewing direction as a direction of a user's line of sight for the VR space; arrange in the VR space, a plurality of live-action images captured by a plurality of cameras respectively having different imaging directions of imaging a real space, so as to have an overlap area in which viewing regions of adjacent live-action images are partially overlapped with each other; generate the VR image according to the viewing direction; and dynamically switch based on the viewing direction the live-action image to be displayed in the overlap area between the adjacent live-action images.

A display control apparatus in another aspect of the present invention, including a processor and a memory storing instructions executable by the processor, that, when executed by the processor, causes the processor to display as a stereoscopic image to which binocular parallax is applied, a VR image of a field of vision from a virtual viewpoint in a virtual reality (VR) space on a display unit of a head mount display, specify a viewing direction as a direction of a user's line of sight for the VR space; arrange in the VR space, a plurality of live-action images captured by a plurality of cameras respectively having different imaging directions of imaging a real space, so as to have an overlap area in which viewing regions of adjacent live-action images are partially overlapped with each other; generate the VR image according to the viewing direction; and dynamically switch based on the viewing direction the live-action image to be displayed in the overlap area between the adjacent live-action images.

A display control method in another aspect of the present invention, includes: displaying as a stereoscopic image to which binocular parallax is applied, a VR image of a field of vision from a virtual viewpoint in a virtual reality (VR) space on a display unit of a head mount display, specifying a viewing direction as a direction of a user's line of sight for the VR space; arranging in the VR space, a plurality of live-action images captured by a plurality of cameras respectively having different imaging directions of imaging a real space, so as to have an overlap area in which viewing regions of adjacent live-action images are partially overlapped with each other; generating the VR image according to the viewing direction; and dynamically switching based on the viewing direction the live-action image to be displayed in the overlap area between the adjacent live-action images.

The object, characteristics and advantages of the present invention become more apparent by the detailed explanation and the accompanying drawings below.

### BRIEF DESCRIPTION OF THE DRAWINGS

FIG. 1 is a schematic block diagram illustrating an example of a hardware configuration of an image display system according to one embodiment of the present invention.

FIG. 2 is a diagram in which directions in a VR space are defined.

FIG. 3 is a diagram for explaining a VR image showing a field of vision from a virtual viewpoint in a VR space.

FIG. 4 is a diagram for explaining problems with a live-action image captured by one stereo camera.

FIG. 5 is a diagram illustrating an example of capturing an image using a plurality of stereo cameras.

FIG. 6 is a diagram for explaining an example in which a misalignment occurs between images respectively captured by two adjacent cameras.

FIG. 7 is a diagram illustrating an example in which an area is divided into two and images are captured by two cameras with different imaging directions.

FIG. 8 is a diagram conceptually illustrating an example of respective viewing regions of live-action images captured by two cameras with different imaging directions.

FIG. 9 is a diagram conceptually illustrating an example in which adjacent live-action images are arranged in a VR space so that viewing regions of the adjacent live-action images partially overlap with each other.

FIG. 10 is a diagram illustrating an example in which a first image is displayed in an overlap area in a VR space.

FIG. 11 is a diagram illustrating an example in which a second image is displayed in an overlap area in a VR space.

FIG. 12 is a diagram illustrating an example in which a reference direction is set outside an overlap area.

FIG. 13 is a diagram illustrating an example of dynamically switching between live-action images to be displayed in an overlap area based on a current region boundary of adjacent live-action images.

FIG. 14 is a functional block diagram schematically illustrating an example of a functional configuration of a display control device.

FIG. 15 is a flowchart illustrating an example of a processing performed by a display control device.

FIG. 16 is a diagram illustrating an example of changing a reference direction.

FIG. 17 is a flowchart illustrating an example of a procedure of changing a reference direction changing.

FIG. 18 is a diagram illustrating an example of a screen displayed on a display unit of an HMD.

FIG. 19 is a diagram illustrating an example of a screen displayed on a display unit of an HMD.

FIG. 20 is a functional block diagram schematically illustrating an example of a functional configuration of a display control device.

FIG. 21 is a diagram illustrating an example of a screen in which a gradient part is displayed together with a boundary line.

FIG. 22 is a diagram illustrating an example of a screen in which a gradient part is displayed together with a boundary line.

FIG. 23 is a flowchart illustrating an example of a procedure of displaying a boundary line.

FIG. 24 is a flowchart illustrating an example of a procedure of gradually switching between live-action images.

FIG. 25 is a diagram illustrating an example of a screen in which a boundary line moves.

FIG. 26 is a diagram schematically illustrating an example in which respective viewing regions of a left image, a front image, and a right image captured by three cameras are arranged in a VR space.

FIG. 27 is a flowchart illustrating an example of a procedure of switching live-action images in an overlap area.

FIG. 28 is a diagram for explaining an example in which an arrangement of images in a VR space is changed according to a scene.

FIG. 29 is a flowchart illustrating an example of a procedure of changing an arrangement of images in a VR space.

FIG. 30 is a diagram schematically illustrating an example of viewing regions in a VR space when the camera of FIG. 26 is rotated to the right.

FIG. 31 is a diagram illustrating an example of viewing regions in a VR space when a rotation information in an imaging direction is not used.

FIG. 32 is a diagram illustrating an example in which viewing regions in a VR space are changed when a rotation information in an imaging direction is used.

FIG. 33 is a flowchart illustrating an example of a procedure of changing a direction of an overall viewing region in a VR space.

FIG. 34 is a diagram illustrating an example of an HMD.

FIG. 35 is a schematic block diagram illustrating an example of a hardware configuration of a stand-alone HMD or an information processing apparatus used as the HMD.

### MODES FOR CARRYING OUT THE INVENTION

Hereinafter, modes for carrying out the present invention will be described with reference to drawings.

### [Example Configuration of Image Display System]

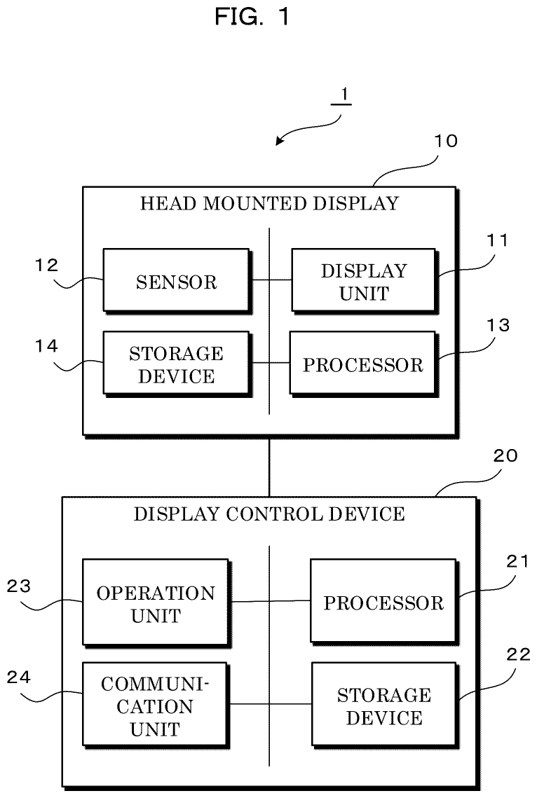

FIG. 1 is a schematic block diagram illustrating an example of a hardware configuration of an image display system 1 according to one embodiment of the present invention. The image display system 1 includes an HMD 10 and a display control device 20 that executes a display control for the HMD 10.

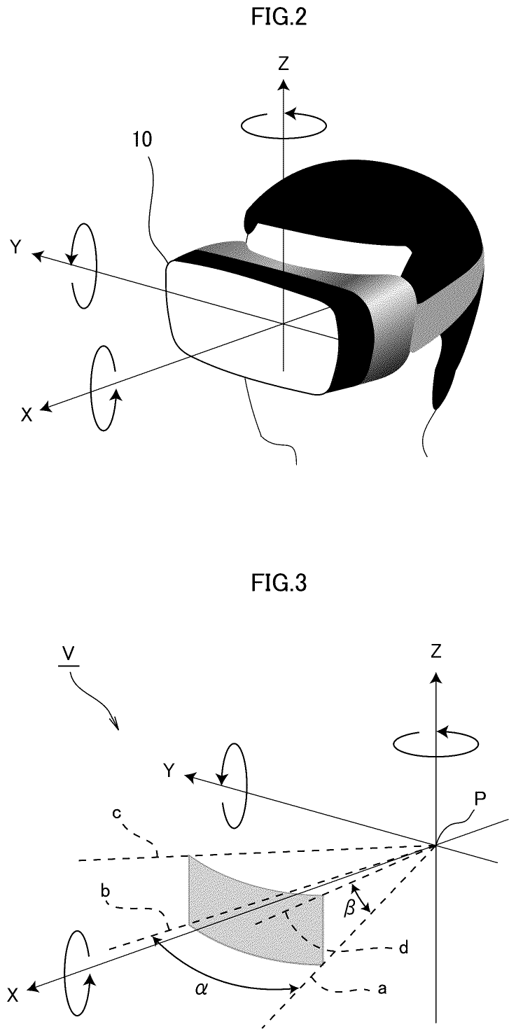

The HMD 10 is worn on a head of a user (see FIG. 2) and can display a stereoscopic image (a still image or a video) with a wide viewing angle using binocular parallax. Further, the HMD 10 is equipped with a sensor 12 such as a gyro sensor or the like, that detects a movement and an inclination of the HMD 10, and further detects a change in movements and an inclination of the head of the user wearing the HMD 10, and a VR image of a field of vision in the VR space is displayed according to the change. For example, when the user's head is moved to the right, the VR image displayed on the HMD 10 changes to a VR image corresponding to a right field of vision in the VR space, and changes to a VR image corresponding to an upward field of vision in the VR space when the user's head is moves upwards. It is therefore possible for a user to have immersive feeling as if he or she was actually there.

The HMD 10 mainly includes a display unit 11, the sensor 12, a processor 13, a storage device 14, and the like.

The display unit 11 is a display that displays various types of information such as VR images, texts and the like. The display unit 11 may be a display of a virtual image projection type on which a virtual image is formed by using, for example, a half mirror or the like. Further, the display unit 11 may be, for example, a display of a retinal projection type that directly forms a VR image on a retina using a crystalline lens of a user's eye. The display unit 11 displays a stereoscopic image (an image for a right eye and an image for a left eye) using binocular parallax as a VR image representing a field of vision from a virtual viewpoint in the VR space.

The sensor 12 detects a position information on a rotation angle, an inclination, etc., of the HMD 10. Based on an output from the sensor 12, the detection information on an orientation of the HMD 10 can be obtained. For example, the sensor 12 is an angular velocity sensor (a gyro sensor) that detects an angular velocity of an object. The sensor 12 may be a sensor that detects a change in direction, or a sensor that detects a direction itself. The sensor 12 is not limited to the gyro sensor, but can be an acceleration sensor, an angular acceleration sensor, an inclination sensor, a magnetometer sensor, or the like, and also the sensor 12 can be realized by appropriately combining them.

The processor 13 functions as a control center that controls respective units of the HMD 10. The processor 13 is, for example, a CPU (Central Processing Unit). The processor 13 may include a hardware such as a GPU (Graphics Processing Unit), a DSP (Digital Signal Processor), or an FPGA (Field Programmable Gate Array) in addition to or instead of the CPU. For example, the processor 13 performs a control of supplying a VR image signal received from the display control device 20 to the display unit 11 via an interface.

The storage device 14 stores a program to be executed by the processor 13 or temporarily stores data and parameters to be processed by the processor 13. For the storage device 14, for example, a Read Only Memory (ROM), a Random Access Memory (RAM), a Video Random Access Memory (VRAM), auxiliary storage device, and the like. For the auxiliary storage device, a non-volatile semiconductor memory, a hard disk drive (HDD), a solid state drive (SSD) or the like can be used.

The HMD 10 may have a network adapter or the like, so that a VR image can be input via a network. Further, the HMD 10 may also include an audio output unit, a GPS (Global Positioning System) receiving unit, or the like.

The display control device 20 is communicatively connected to the HMD 10 wirelessly or wired, and executes display control for the HMD 10. The display control device 20 is, for example, a stationary or portable game machine. The display control device 20 may be a business use (commercial use) game machine installed at an amusement facility or the like. Alternatively, the display control device 20 can be a personal computer, a tablet computer, a smartphone, a mobile phone terminal, a PHS (Personal Handy-phone System) terminal, a personal digital assistant (PDA), or a multifunctional television receiver (so-called smart TV) with an information processing function, or the like.

The display control device 20 mainly includes a processor 21, a storage device 22, an operation unit 23, and a communication unit 24, which are interconnected via bus lines including an address bus, a data bus, a control bus, and the like. In addition, an interface circuit, an image processing unit, a sound processing unit, etc., are interposed between the bus line and each component as necessary, illustrations of which are omitted here.

The processor 21 interprets and executes program instructions and performs an overall control of the display control device 20. The processor 21 can be, for example, a CPU. The processor 21 may also include a hardware such as a GPU, a DSP, or a FPGA or the like in addition to the CPU or in place of the CPU. The storage device 22 includes, for example, a ROM, a RAM, a VRAM, an auxiliary storage device, etc. The ROM stores programs, data, and the like necessary for a basic operation control of the display control device 20. The RAM or the VRAM stores various programs and data and secures a work area for the processor 21. The auxiliary storage device stores programs, various data, and the like. For the auxiliary storage device, for example, a non-volatile semiconductor memory, a hard disk drive, a solid-state drive, or the like can be used.

The display control device 20 may include a recording media drive. Examples of the recording media drive include a DVD-ROM drive, a CD-ROM drive, a hard disk drive, an optical disc drive, a flexible disk drive, a silicon disk drive, a cassette media reader, and the like. In this case, a DVD-ROM, a CD-ROM, a hard disk, an optical disc, a flexible disk, a semiconductor memory, or the like may be used as the recording medium. The recording media drive reads image data, audio data, and program data from the recording medium, and supplies the read data to the RAM or the like of the storage device 22 via a decoder.

For example, the image data including a live-action image of a real space captured beforehand for a VR image, and a program such as a game program including an image data, are stored in the storage device 22 such as an auxiliary storage device, etc. or read from the recording media drive.

The operation unit 23 is provided for a user to input various operation commands to the display control device 20. For example, a user performs operations for viewing a VR image or operations for playing a game containing a VR image. Examples of the operation unit 23 include a position input unit (a component of a touch panel, etc.) having a touch interface, a physical button, a controller, an analog stick, a keyboard, a pointing device, and the like. Further, the operation unit 23 may be configured such that a voice can be input by identifying a voice input from an audio input unit such as a microphone or the like. Further, the operation unit 23 may be configured to perform operations based on user's gestures.

The communication unit 24 includes a communication interface (not illustrated) and has communication control functions for data communication when executing a game, etc. Here, the communication control functions for data communication includes, for example, an internet connection function, a wireless LAN (Local Area Network) connection function, and a short-range wireless communication function using a predetermined frequency band (for example, a 2.4 GHz frequency band). The communication unit 24 transmits a connection signal for connecting the display control device 20 to the network based on an instruction from the processor 21, and receives an information transmitted from a communication partner side and supplies the information as received to the processor 21.

As will be described later, according to the image display system 1 or the display control device 20 of the present embodiment, when displaying a VR image on the HMD 10, it is possible to reduce a sense of discomfort of a seam (misalignment) between a plurality of live-action images captured by a plurality of cameras without performing a stitching processing. It is therefore possible to receive a live video at a remote location distributed via a network by the communication unit 24, and to display the live image as received as a VR image on the HMD 10 almost in real time.

Further, to the display control device 20, a tracking unit that detects a position of the HMD 10 (or a position of the user's head wearing the HMD 10) may be connected. For example, the HMD 10 includes a plurality of light sources (LEDs, etc.,) for tracking, and the tracking unit includes an imaging unit for imaging the HMD 10. The tracking unit which is fixed at a predetermined position defines a position of the HMD 10 based on the positions of the plurality of light source units in the image captured by the imaging unit. Further, the display control device 20 may include a display unit such as a liquid crystal display or an organic EL (Electro-Luminescence) display, or the like.

### 2. DIRECTIONS OF VR SPACE

FIG. 2 is a diagram in which directions are defined in a VR space according to the present embodiment. In the present embodiment, a vertical direction in which a user, who wears the HMD 10 which displays a VR image in a VR space is upright, is defined to be a Z axis. An axis in a horizontal direction orthogonal to the Z axis, which is a viewing direction of the user facing the front (a reference viewing direction for the VR space) is defined to be an X axis, and an axis in a horizontal direction orthogonal to the Z axis and the X axis is defined to be a Y axis.

For example, when the image display system 1 is activated, a viewing axis direction of the HMD 10 (a direction orthogonal to a display surface of the display unit 11 of the HMD 10) is set as the reference viewing direction for the VR space. Further, for example, it may be configured such that a user wearing the HMD 10 on his/her head and facing the front can adjust the reference viewing direction with respect to the VR space by performing a predetermined operation.

Here, a change in a rotational direction about the Z axis is defined to be a change in the yaw direction (a left-right direction), a change in a rotational direction about the Y axis is defined to be a change in a pitch direction (an up-down direction), and a change in a rotational direction about the X axis is defined to be a change in a roll direction. For example, the above-described sensor 12 of the HMD 10 detects an angular velocity or an angular acceleration in the rotational direction (a yaw direction, a pitch direction, and a roll direction) of each axis. A change in the yaw direction may be defined to be a change in the left-right direction, and a change in the pitch direction may be defined to be a change in the up-down direction.

FIG. 3 is a diagram which explains a VR image (field-of-view image) from a virtual viewpoint in the VR space according to the present embodiment. In this figure, the virtual viewpoint P (a user's virtual viewpoint) in the VR space V is defined to be an intersection point (origin) of the X-axis, the Y-axis, and the Z-axis. For example, it is assumed that a user is facing the front and a user's viewing direction with respect to the VR space V is in the X axis (a reference viewing direction). In this case, a range of the VR image representing a field of vision from the virtual viewpoint P in the VR space V is a range defined by the yaw angle α (an interior angle between a dashed line a and a dashed line b, and an interior angle between a dashed line c and a dashed line d), and a pitch angle β (an interior angle between the dashed line a and the dashed line d, and an interior angle between the dashed line b and the dashed line c) about the reference viewing direction (X-axis direction). Here, the yaw angle α is a horizontal viewing angle, and the pitch angle β is a vertical viewing angle, and these are set beforehand as the viewing angles of the VR image to be displayed on the HMD 10 in the image display system 1.

For example, when the head of the user wearing the HMD 10 changes in direction in the pitch direction or the yaw direction, the corresponding change in an orientation or a posture of the HMD 10 (a change in a visual axis direction of the HMD 10) is detected by the sensor 12 and the like. Based on a detection information of this sensor 12 and the like, the processor 21 of the display control device 20 determines that a viewing direction with respect to the VR space V has changed from the X axis direction (the reference viewing direction) to the pitch direction or the yaw direction. According to the change in the viewing direction with respect to the VR space V, the range of the VR image displayed on the display unit 11 is changed. Similarly, when the head of the user wearing the HMD 10 changes in the roll direction, the change is detected by the sensor 12 and the like, and the range of the VR image displayed on the display unit 11 rotates in the roll direction while the viewing direction remains in the X-axis direction. Thus, according to the orientation (posture) of the HMD 10, the range of the VR image displayed on the display unit 11 is changed.

Additionally, in the VR space V, other than live-action images, various objects, lines, symbols, or characters, etc., can be arranged as necessary. For example, it may be configured such that the “boundary line” to be described later and the like are superimposed on the live-action VR image to be displayed on the display unit 11.

In the case of displaying a stereoscopic image using binocular parallax, viewing directions exist respectively corresponding to virtual viewpoints for the right eye and the left eye, and a VR image for the right eye and a VR image for the left eye in the respective viewing directions are displayed on the display unit 11 of the HMD 10.

### 3. LIVE-ACTION IMAGES CAPTURED BY CAMERA

In the image display system 1 of the present embodiment, using a live-action image captured by a camera that captures a real space, a stereoscopic VR image is generated using binocular parallax and is displayed on the HMD 10. Before describing the live-action image to be used in the image display system 1 of the present embodiment, explained is a problem in a live-action image captured by one camera.

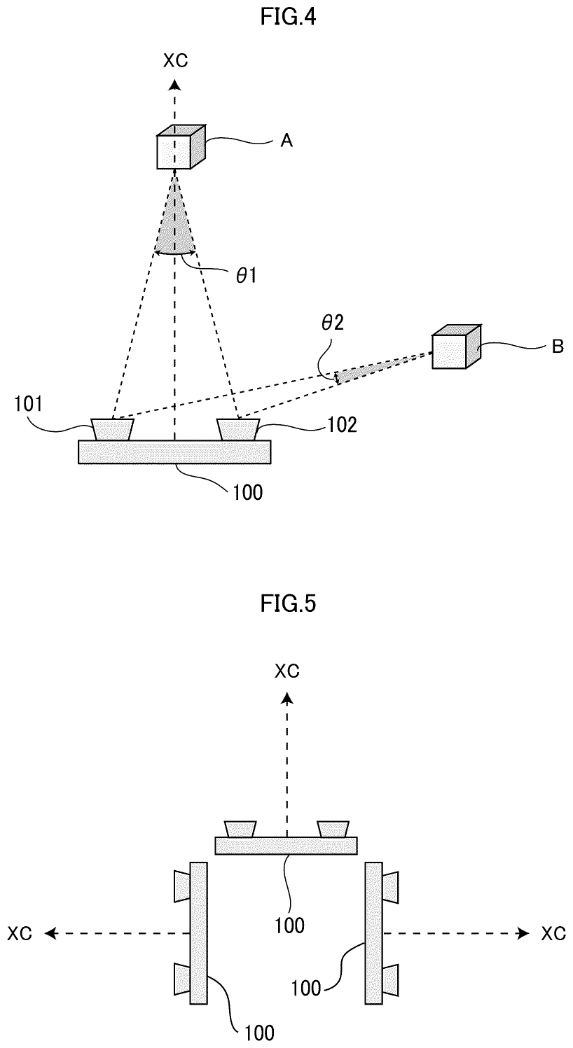

FIG. 4 is a diagram for explaining problems with a live-action image captured by one camera 100 (a so-called stereo camera) equipped with a left eye camera 101 and a right eye camera 102. The camera 100 captures objects A and B at different positions in real space but at the same distance from the camera 100. The object A is positioned in a visual axis direction (nearly equal to a lens center direction) XC of the camera 100, and the object B is positioned in the right direction with respect to the visual axis direction XC. Here, an angle θ2 formed by the object B and the left eye camera 101 and the right eye camera 102 is smaller than the angle (congestion angle) 01 formed by the object A and the left eye camera 101 and the right eye camera 102, even though the objects A and B are positioned at the same distance from the camera 100. For this reason, there is a problem in that it is difficult to recognize a sense of distance and see an image in stereoscopic in the direction with a significantly large angle from the visual axis direction XC of the camera 100.

In order to solve the above problem, as exemplified in FIG. 5, it is effective to capture an image by dividing a plurality of the cameras 100 respectively having different imaging directions of imaging a real space. In the example of FIG. 5, the imaging area is divided into three regions of the left, the front, and the right regions by the three cameras 100 to capture an image. In this manner of dividing the entire imaging area into multiple regions, a visual axis direction is formed in each of divided imaging regions for each of the cameras 100, and it is therefore possible to reduce the direction in which an angle deviates greatly from the visual axis direction XC. As a result, by using the plurality of images captured by the plurality of cameras 100 respectively having different imaging directions, it is possible to suppress the foregoing problem that the image is difficult to be seen stereoscopically.

Conventionally, a plurality of images captured by the plurality of cameras for divided areas were finally converted into one piece of image data. For this reason, it was necessary to perform a stitching process to connect adjacent images captured by the respective cameras. This stitching process can be done automatically using a dedicated software. However, in order to create a more natural image with no seams, it is necessary to perform the stitching process manually which takes time. One of the reasons why the stitching process is time consuming lies in that the misalignment of the positions of the respective cameras used for imaging. Namely, to capture the real space, the cameras are set in close proximity, yet it is still not physically possible to place the cameras precisely at the same position at the same time. Therefore, the misalignment occurs near the boundary region between the adjacent images captured by the adjacent cameras. This will be explained below.

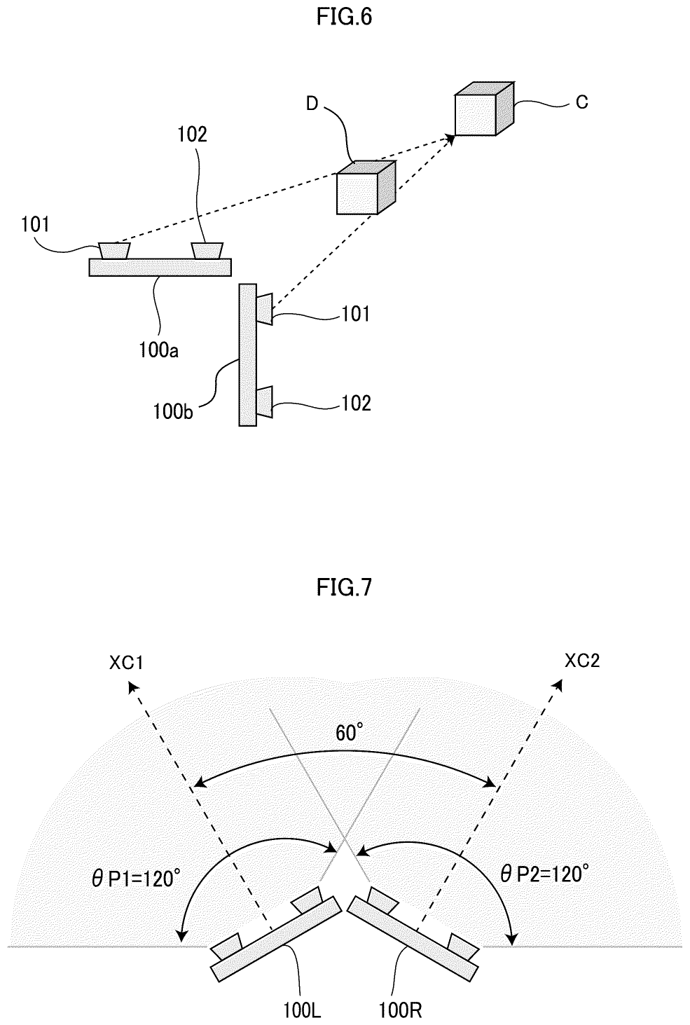

FIG. 6 is a diagram which explains an example in which a misalignment occurs between the image captured by the camera 100a which captures the front area and the image captured by the camera 100b which captures the right area. Here, for the sake of convenience, an example will be described in the case of imaging with the respective left eye cameras 101 of the two cameras 100a and 100b, but the same can be applied to the case of imaging with the respective right eye cameras 102. The target objects C and D to be imaged are positioned on the right side of the camera 100a and on the left side of the camera 100b, and are positioned near the boundary region of the imaging area of the cameras 100a and 100b. Further, the object C is positioned behind the object D (at a position away from the cameras 100a and 100b). In this case, when capturing the image with the camera 100a that captures the front area, an image is captured in such a way that the object D is positioned slightly to the right of the object C in the back. On the other hand, when capturing the image with the camera 100b which captures the right area, an image is captured in such a manner that the object D is positioned slightly to the left of the object C. Thus, although the cameras 100a and 100b simultaneously capture the same objects C and D, there is a clear misalignment in the images captured by these cameras.

In the conventional stitching process, it is necessary to manually process the image to make the described misalignment between the adjacent images less noticeable to realize a more natural image, which takes time. The level of misalignment around the boundary region between the adjacent images depends on the distance between the cameras 100a and 100b and the imaging target. That is, it the case where there exists a significant distance between the imaging target (the objects C, D, etc.) positioned around the boundary region and the cameras 100a and 100b, the level of misalignment between adjacent images is small. In this case, it is therefore possible to perform the conventional stitching process with ease. On the other hand, it the case where the imaging target around the boundary region is positioned in a vicinity of the cameras 100a and 100b, the level of misalignment between the adjacent images becomes relatively large. In this case, it is difficult to perform the stitching process. More specifically, in the case where the distance between the imaging target and the cameras 100a and 100b set in the vicinity of the boundary region is smaller than a certain distance (for example, 2 m or less), the level of misalignment between adjacent images becomes significantly large, which makes the stitching process difficult. Therefore, in the conventional case where a plurality of images captured by multiple cameras are finally stitched into one piece of VR image data, it is practically not possible to create VR image data including a close-range imaging target positioned at less than a certain distance from the cameras.

In response, according to the image display system 1 or the display control device 20 of the present embodiment, the below-explained display control of the VR image is performed with respect to the plurality of images captured by the plurality of cameras without performing the conventional stitching process.

### 4. VR IMAGE DISPLAY CONTROL

In the following, explained is the outline of the VR image display control performed by the image display system 1 or the display control device 20 of the present embodiment. That is, the image display system 1 or the display control device 20 performs characteristic processes of arranging a plurality of live-action images captured by a plurality of cameras having different imaging directions for capturing the real space in the VR space without performing the stitching process. Here, when the plurality of live-action images are arranged in the VR space in such a manner that respective viewing regions of the adjacent live-action images are partially overlapped with each other. Then, according to the viewing direction (the direction which can be determined to be the user's viewing direction) with respect to the VR space, the boundary regions between the adjacent live-action images in the overlapped region are dynamically switched. As a result, by keeping the misalignment of the images, which is likely to generate at the boundary region between the adjacent live-action images, away from the viewing direction as far as possible, it is possible to realize a characteristic display control, which can display on the HMD 10, a VR image with reduced unnatural discomfort due to the misalignment without performing the stitching process.

For simplicity, explanations of the VR image display control of the present embodiment will be given through the case where the imaging area is divided into two areas in the left and right directions to make the horizontal viewing angle larger (that is, the case of two live-action images captured by two cameras in the left direction and the right direction respectively). Here, the imaging area can be divided into any number of not less than 2 (two). Specifically, the imaging area may be divided into 3 (three) areas in the left direction, the front direction, and the right direction as described above, or may be divided into four divided areas also in the rear direction. The imaging area may be further divided into eight divided areas in eight directions. Further, to make a vertical viewing angle larger, the imaging area may be divided into two directions of up and down directions (or three or more directions). Additionally, in the following, for simplicity of the explanations, only the yaw direction (left and right direction) is to be considered for the inclination of the HMD 10, without considering the pitch direction (the vertical direction) nor the roll direction (the visual axis rotational direction). Further, in the case where a stereoscopic VR image using binocular parallax is displayed on the display unit 11 of the HMD 10, a VR image for the right eye and a VR image for the left eye are displayed respectively. However, hereinafter, for simplicity of the explanations, desecrations will be given without making distinction between for the right eye and for the left eye.

FIG. 7 is a diagram illustrating an example in which an area with a horizontal angle of 180 degrees is divided into two, and images are captured using two stereo cameras having different imaging directions. A horizontal angle of view θP1 of a first camera 100L that captures the area in the left direction is 120 degrees, and a horizontal angle of view θP2 of a second camera 100R that captures the area in the right direction is also 120 degrees. The angle formed by a visual axis direction XC1 of the first camera 100L and a visual axis direction XC2 of the second camera 100R is 60 degrees, and the first camera 100L and the second camera 100R are arranged in close proximity.

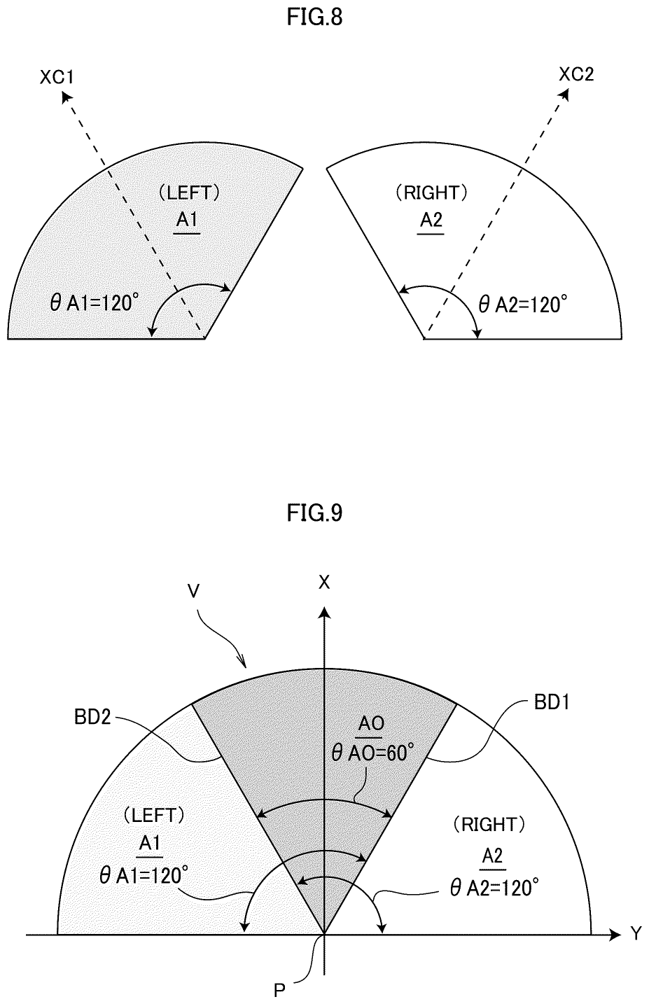

FIG. 8 is a conceptual diagram illustrating a viewing region A1 of the first image captured by the first camera 100L and a viewing region A2 of the second image captured by the second camera 100R. In practice, in each of the viewing region A1 of the first image and the viewing region A2 of the second image, there exist an image for the right eye and an image for the left eye. In the following, however, either one of the images for the right eye and the image for the left eye is considered. Here, the “viewing region” is a region which can be displayed on the display unit 11 of the HMD 10 in the live-action image captured by one camera, and which is an area where the live-action image is arranged in the VR space. In the example of FIG. 8, the viewing angle θA1 of the viewing region A1 of the first image and the viewing angle θA2 of the viewing region A2 of the second image are both 120 degrees. Then, as exemplified in FIG. 9, the adjacent viewing regions A1 and A2 constitute an overall viewing region of 180 degrees.

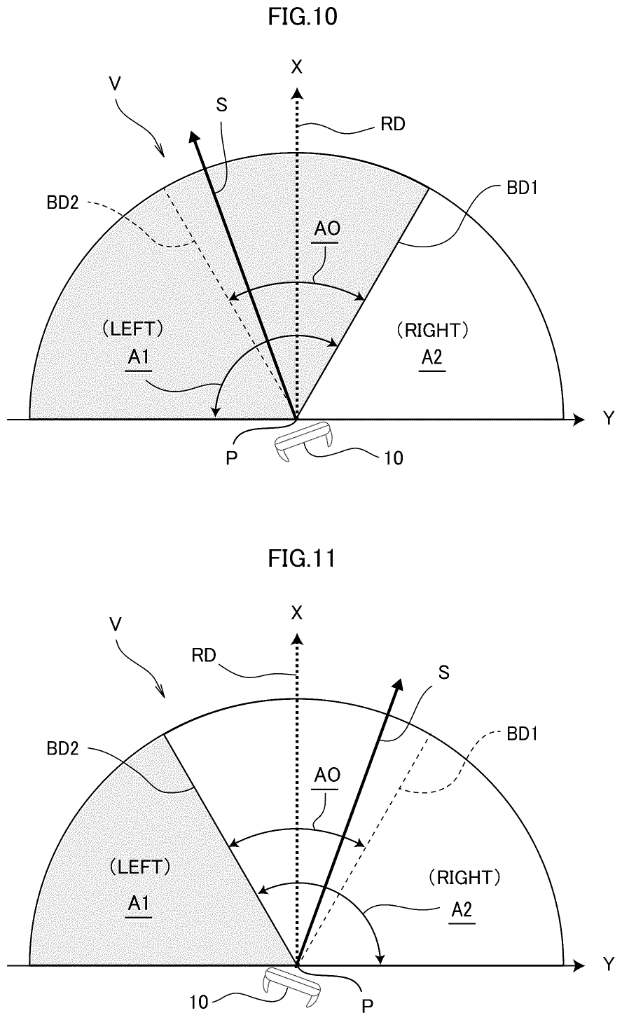

FIG. 9 is a diagram conceptually illustrating an example in which the first image on the left side and the second image on the right side are arranged in the VR space V so that the viewing region A1 of the first image and the viewing region A2 of the second image are partially overlapped in an overlap area AO. In other words, FIG. 9 is a diagram conceptually illustrating an XY cross-section of the VR space V in which the first image and the second image are arranged (The same can be applied for, for example, FIG. 10, etc., to be described later, in which the VR space V is shown). In the example of FIG. 9, the overall viewing region of the VR space Vis 180 degrees, the viewing angle θA1 of the viewing region A1 of the first image is 120 degrees, and the viewing angle θA2 of the viewing region A2 of the second image is 120 degrees. Therefore, the viewing angle θAO of the overlap area AO where the viewing regions A1 and A2 are overlapped is 60 degrees. The overlap area AO is the region sandwiched between the region boundaries BD1 and BD2 of the first image and the second image. In the example of FIG. 9, the direction from the virtual viewpoint P in the VR space V through the center of the overlap area AO is the X axis direction. Then, either the first image or the second image is selectively displayed in the overlap area AO. Further, the viewing region of only the first image (the area sandwiched between the Y axis and the region boundary BD2) and the viewing region of only the second image (the area sandwiched between the Y axis and the region boundary BD1) both have a viewing angle of 60 degrees.

FIG. 10 is a diagram illustrating an example in which the first image (the viewing region A1 of the first image) is displayed in the overlap area AO in the VR space V. FIG. 11 is a diagram illustrating an example in which the second image (the viewing region A2 of the second image) is displayed in the overlap area AO in the VR space V. When the first image of the viewing region A1 on the left side is selectively displayed in the overlap area AO, the boundary between the first image and the second image is the rightmost region boundary BD1 of the overlap area AO, as exemplified in FIG. 10. On the other hand, when the second image of the viewing region A2 on the right side is selectively displayed in the overlap area AO, the boundary between the first image and the second image is the leftmost region boundary BD2 of the overlap area AO, as exemplified in FIG. 11. Thus, by selectively switching the live-action images (between the first image and the second image) to be displayed in the overlap area AO, the region boundaries (BD1, BD2) between adjacent live-action images change.

Whether the first image or the second image is displayed in the in the overlap area AO is determined based on the viewing direction S. The viewing direction S can be specified based on the detection information by the sensor 12, etc., of the HMD 10 (that is, based on the orientation of the HMID 10). Therefore, an example of switching the live-action images to be displayed in the overlap area AO based on the yaw direction of the HMD 10 will be described, assuming that the visual axis direction of the HMD 10 is the viewing direction S.

In FIG. 10 and FIG. 11, to illustrate the relationship between the orientation of the HMD 10 (the visual axis direction of the HMD 10) and the display switching of the overlap area AO in the VR space V, an image of the orientation of the HMD 10 is displayed in the vicinity of the virtual viewpoint P (the same can be applied to the below-explained figures illustrating the VR space V).

FIG. 10 and FIG. 11 illustrate examples in which the “reference direction RD” is set as a criterion for switching live-action images to be displayed in the overlap area AO in the direction from the virtual viewpoint P through the center of the overlap area AO. In the example of FIG. 10, the viewing direction S (the visual axis direction of the HMD 10) is on the left (i.e., the first image side) of the reference direction RD. In this case, the first image of the viewing region A1 on the left side is displayed in the overlap area AO. In this case, the boundary between the viewing region A1 of the first image and the viewing region A2 of the second image is the region boundary BD1. Thus, the region boundary BD1 is away from the viewing direction S.

On the other hand, in the example of FIG. 11, the viewing direction S (the visual axis direction of the HMD 10) is on the right (i.e., the second image side) of the reference direction RD. In this case, the second image of the viewing region A2 on the right side is displayed in the overlap area AO. In this case, the boundary between the viewing region A1 of the first image and the viewing region A2 of the second image is the region boundary BD2. Thus, the region boundary BD2 is away from the viewing direction S.

As in the above example, a specific direction (in the above case, the direction from the virtual viewpoint P through the center of the overlap area AO) is set as the reference direction RD, and the live-action images (the first image or the second image) displayed in the overlap area AO is dynamically switched by considering the orientation of the HMD 10 (the visual axis direction of the HMD 10) as the viewing direction S. In this way, the seam (misalignment) of the image that tends to occur at the region boundary (BD1 or BD2) of the adjacent live-action images can be kept away from the direction of the user's line of sight, and a sense of discomfort of a seam (misalignment) can be reduced. As a result, even in the case where an object taken at close range exists in or in the vicinity of the region boundary, it is possible to display VR images with less sense of discomfort for the user. In addition, since VR images can be generated without requiring the stitching process, it is also possible to reduce the time and effort required to create VR images.

### (Setting Reference Direction RD)

In the above, explanations have been given through the example in which the reference direction RD is set in the direction from the virtual viewpoint P through the center of the overlap area AO. However, it is not intended to be limited to this example. The reference direction RD may be set in any direction from the virtual viewpoint P as long as it is within the viewing region where the first image and the second image are arranged in the VR space V.

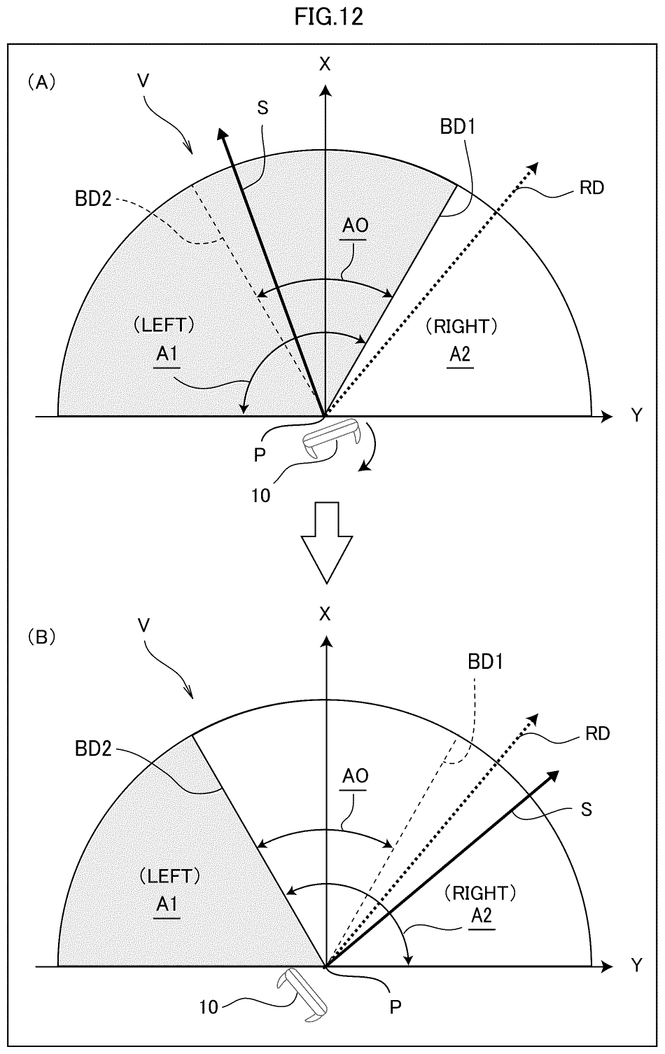

For example, as illustrated in FIG. 12, it is also possible to set the reference direction RD to a direction from the virtual viewpoint P to a position outside the overlap area AO. FIG. 12 shows an example in which the reference direction RD is set in the viewing region A2 of only the second image without including the overlap area AO. In this case also, when the viewing direction S exceeds the reference direction RD from the state (A) in FIG. 12 due to a change in the yaw direction (the left and right direction) of the HMD 10, as illustrated in the example of the state (B) in FIG. 12, the live-action image displayed in the overlap area AO is switched from the first image in the viewing region A1 to the second image in the viewing region A2. As a result, the region boundary of the adjacent live-action images is switched from the region boundary BD1 to the region boundary BD2, to be away from the viewing direction S. However, in this case, in the state (A) in FIG. 12, the viewing direction S crosses the region boundary BD1 until the viewing direction S exceeds the reference direction RD. For this reason, at some timing before the live-action image displayed in the overlap area AO is switched from the first image to the second image, the region boundary BD1 overlaps with the viewing direction S.

Therefore, it is preferable that the reference direction RD is set to the direction from the virtual viewpoint Pto a predetermined position in the overlap area AO (may be the center or may not be the center of the overlap area AO). In this case, since the reference direction RD is set in the overlap area AO (see FIG. 10 or FIG. 11), even if the viewing direction Sis moved towards the current region boundary (BD1 or BD2) of the overlap area AO, the viewing direction S exceeds the reference direction RD and the live-action image to be displayed in the overlap area AO is switched before reaching the region boundary. As a result, the region boundary is moved away from the viewing direction S before the viewing direction S reaches the region boundary.

(Embodiment in which Reference Direction is not Set)

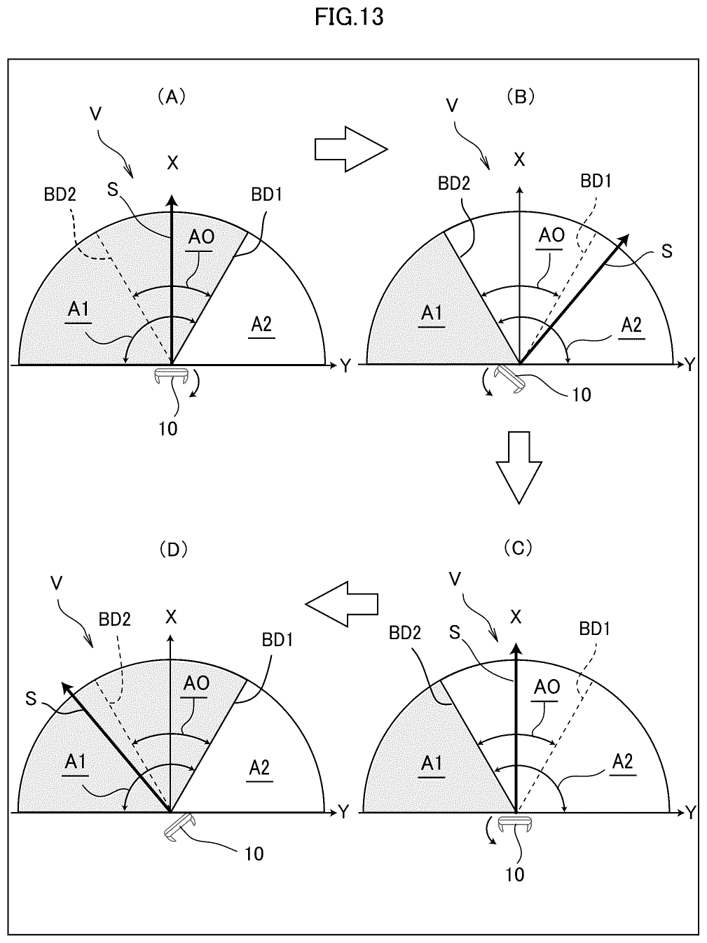

Next, explained is an embodiment wherein the live-action image displayed in the overlap area AO is dynamically switched between the adjacent live-action images (the first image or the second image) based on the viewing direction S without setting the reference direction RD. In this embodiment, as illustrated in the example of FIG. 13, the live-action image displayed in the overlap area AO is dynamically switched based on the viewing direction S with reference to the current region boundary (BD1 or BD2) between the adjacent live-action images.)

For example, as illustrated in (A) in FIG. 13, it is assumed that the first image of the viewing region A1 on the left side is displayed in the overlap area AO, and the viewing direction S exists on the X axis. In this case, the criterion for the switching of the live-action images is the current region boundary BD1. From this state, the HMD 10 rotates in the right direction, and as illustrated in the example (B) in FIG. 13, when the viewing direction S (the visual axis of the HMD 10) exceeds the region boundary BD1, the live-action image displayed in the overlap area AO is switched from the first image to the second image of the viewing region A2 on the right side. As a result, the criterion for the switching of the live-action image is changed to the current region boundary BD2. From this state, the HMD 10 rotates in the left direction, and as illustrated in the sample (C) in FIG. 13, even if the viewing direction S is moved back to the X axis, since the viewing direction S does not exceed the current region boundary BD2, the live-action image displayed in the overlap area AO is not switched. From this state, the HMD 10 further rotates in the left direction, and as illustrated in the example (D) in FIG. 13, when the viewing direction S exceeds the current region boundary BD2, the live-action image to be displayed in the overlap area AO is switched from the second image to the first image.

As described, with reference to the current region boundary (BD1 or BD2) of the adjacent live action images (the first image and the second image), the live action image is dynamically switched between the first image and the second image in such a manner that the first image is displayed when the viewing direction S is on the first image side (left side) of the current region boundary (BD1 or BD2), and the second image is displayed when the viewing direction S is on the second image side (right side) of the current area boundary (BD1 or BD2).

As a modified example, the live-action image displayed in the overlap area AO may be dynamically switched in the following manner. That is, when the viewing direction S approaches the current region boundary (BD1 or BD2) of the adjacent live-action images to more than a predetermined amount (for example, the angle formed by the viewing direction S and the current region boundary becomes less than or equal to a predetermined angle), the live-action image currently displayed in the overlap area AO may be switched to the other live-action image. In this modification, the live action image displayed in the overlap area AO is switched before the viewing direction S reaches the region boundary, and the region boundary is moved away from the viewing direction S.

The foregoing explanations given with reference to FIG. 9 to FIG. 13 have been given through the case of the display control wherein the horizontal viewing angle is broadened by dividing the imaging area in the horizontal direction into a plurality of regions. However, in the case of the display control wherein the vertical viewing angle is broadened by dividing the imaging area in the vertical direction into a plurality of regions, the process of switching the image in the overlap area may be performed in the same manner based on the orientation of the HMD 10 of the pitch direction (up and down direction).

### 5. FUNCTIONAL CONFIGURATION OF DISPLAY CONTROL DEVICE

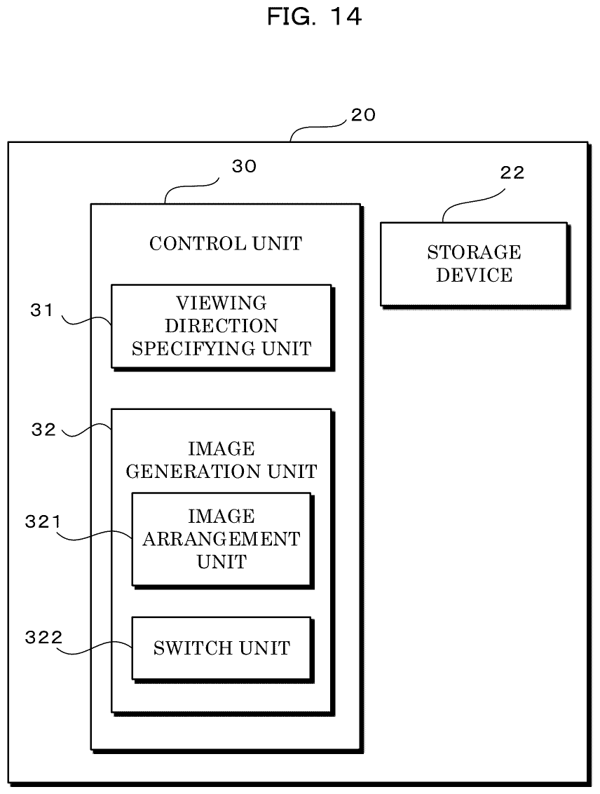

FIG. 14 is a schematic functional block diagram illustrating an example of a functional configuration of the display control device 20. The display control device 20 executes control for displaying on the display unit 11 of the HMD 10, a VR image of a field of vision from a virtual viewpoint in the VR space as a stereoscopic image using binocular parallax. As illustrated in FIG. 14, the display control device 20 includes a control unit 30. The control unit 30 is realized, for example, by the processor 21 executing a program stored in the storage device 22. The control unit 30 includes a viewing direction specifying unit 31 and an image generation unit 32.

The viewing direction specifying unit 31 has a function of specifying a viewing direction that is the direction of the user's line of sight with respect to the VR space. Here, the “viewing direction” is defined regarding it as the direction of the user's line of sight with respect to the VR space wearing the HMD 10. The “viewing direction” can be defined, for example, based on the detection information of the sensor 12, etc., of the HMD 10, which can be roughly considered as the direction of the user's line of sight. The viewing direction may coincide with the direction of the actual line of sight of the user wearing the HMD 10, or may be slightly displaced from the direction of the actual line of sight of the user.

For example, the viewing direction specifying unit 31 obtains the detection information related to the orientation of the HMD 10. The viewing direction specifying unit 31 can define the viewing direction based on the detection information as obtained. Here, “the detection information related to the orientation of the HMD 10” is defined to be the detection information related to the orientation of the HMD 10, which changes when a user changes the direction of his or her head wearing the HMD 10. The foregoing “detection information” can be obtained from the detection means such as a sensor, etc., that detects the orientation or the change in direction of the HMD 10.

For example, a result of detection by the sensor 12 (an angular rate sensor, an acceleration sensor, a magnetometer, etc.) built into the HMD 10 corresponds to an example of “the detection information related to the orientation of the HMD 10”. Additionally, a result of measurement of a tracking system which captures an image of the HMD 10 by an imaging unit provided outside the HMD 10 to measure the position, the direction, etc., of the HMD 10 corresponds to an example of “the detection information related to the orientation of the HMD 10”. Further, a result of measurement of the tracking system, which analyzes the surrounding objects captured by the imaging unit mounted on the HMD 10 itself to measure the position, the orientation, etc., of the HMD 10 corresponds to an example of “the detection information related to the orientation of the HMD 10”.

Further, the viewing direction specifying unit 31 obtains the detection information related to the user's line of sight. The viewing direction specifying unit 31 can specify the viewing direction based on the detection information as obtained. Here, “the detection information related to the user's line of sight” is the detection information of the direction of the line of sight, the movement, etc., of the user wearing the HMD 10. For example, a result of measurement of an eye tracking system which tracks the direction and the movement of the line of sight based on the user's eye positions corresponds to an example of “the detection information related to the user's line of sight”.

The image generation unit 32 has a function of generating a VR image according to the viewing direction by arranging in a VR space a plurality of live-action images captured by a plurality of cameras having different imaging directions of imaging the real space so that the respective viewing regions of the adjacent live-action images partially overlap with each other.

Here, “the camera” is defined to be a real camera that captures real space. Note here that “the camera” itself is not included in the components of the display control device 20. “The camera” includes an optical system for the left eye (camera for the left eye) that captures an image for the left eye and an optical system for the right eye (camera for the right eye) that captures an image for the right eye in order to obtain a stereoscopic image using the left and right binocular parallax.

For example, like a stereo camera, one camera may have both an optical system for the left eye and an optical system for the right eye. Further, the camera for the left eye and the camera for the right eye may have different configurations. In order to generate a VR image with a wide viewing angle from a plurality of live-action images, that can be stereoscopically viewed, a plurality of cameras for the left eye and a plurality of cameras for the right eye are used. For example, when obtaining a wide viewing angle image in which the horizontal viewing angle is broaden, a plurality of cameras may be arranged in the horizontal direction to have different imaging directions in a real space. Similarly, for example, when obtaining a wide viewing angle image in which the vertical viewing angle is broaden, a plurality of cameras may be arranged in the vertical direction to have different imaging directions in the real space. For the left eye and the right eye respectively, the number of cameras is not limited, and any number not less than two of cameras may be adopted. Also, the angle of view of each camera can be set arbitrary. All of the respective angles of view of the plurality of cameras may be or may not be the same.

Additionally, “the imaging direction” is defined to be a direction in which a camera images a real space, which is a front direction (the direction indicating an object to be imaged) on the optical axis of an imaging optical system of the camera.

The “adjacent live-action images” refer to two live-action images captured by two adjacent cameras in which the respective directions of imaging the real space are different and the respective imaging ranges partially overlap with each other. Here, the two adjacent cameras do not refer to the camera for the left eye and the camera for the right eye, but refer to the two cameras both of which capture the live-action image for the left eye, or the live-action image for the right eye. The “live-action image” may be a moving image or a still image. Further, the “live-action image” may be an image (video) captured beforehand, or a live image (video) captured substantially in real time.

Further, the “viewing region” is an area of a live-action image captured by one camera, that can be displayed in the display unit of the head-mounted display, and “the viewing region” is an area in which the live-action image is arranged in the VR space. For example, the viewing region of the live-action image captured by a camera having a horizontal angle of view θH1 (for example, 120 degrees) and a vertical angle of view θV1 (for example, 120 degrees) is basically an area having a horizontal viewing angle θ2 (=θH1) and a vertical viewing angle θV2 (=θV1).

Here, the area of the viewing region of the live-action image captured by the camera having a horizontal angle of view θH1 and a vertical angle of view θV1 may be reduced when arranging the live-action image in the VR space, to set the horizontal viewing angle be θH2 (<θH1) and the vertical viewing angle be θV2 (<θV1) respectively. For example, by not using region in a vicinity of the edge of the image where a distortion due to distortion of the optical system is likely to occur, the area of the viewing region of the live-action image may be reduced when arranging the live-action image in the VR space as described above.

The “overlap area” refers to a region in which two adjacent live-action images partially overlap with each another in the VR space. In the examples of FIG. 9 to FIG. 13, the viewing angle of the overlap area AO is set 60 degrees. However, the viewing angle of the overlap area may be set narrower or wider than 60 degrees. Similarly, the width (viewing angle) of “the overlap area” can be set arbitrarily. As will be described later, when there exist a plurality of overlap areas in the VR space, the respective widths (viewing angles) of all overlap areas may be the same, or at least the width of one overlap area may differ from the width(s) of other overlap area(s).

The image generation unit 32 includes an image arrangement unit 321 in which a plurality of live-action images are arranged in the VR space so that an overlap area exists in which the respective viewing regions of the adjacent live-action images overlap with each other. The image arrangement unit 321 executes a storage control for storing a plurality of live-action images in a predetermined storage area (a storage area for storing a plurality of live-action images respectively to be arranged in the VR space) of the storage device 22 (VRAM, etc.) for forming the VR space. In the examples of FIG. 9 to FIG. 13, the image arrangement unit 321 stores the data of the first image and the data of the second image respectively in the predetermined storage area of the storage device 22 for forming a VR space.

According to the present embodiment, the arrangement information for arranging the plurality of live-action images in the VR space is stored in the storage device 22 together with the data of a plurality of live-action images which are targets of display in association with the plurality of live-action images. Alternatively, the recording medium for storing a plurality of images which are the targets of display also store therein the above arrangement information.

When the processor 21 of the display control device 20 reads out the data of the plurality of images which are the targets of display from the recording medium, and stores the data as read in the storage device 22, the arrangement information is also read out from the recording medium and stored in the storage device 22, to be used for the processing of the image arrangement in the VR space. Alternatively, as will be described later, in the case where the live-action image is displayed on the HMD 10 as the VR image substantially in real time, the arrangement information is also input (received) together with the image of the live video which is the target of display, and the processor 21 use the data for the processing of the image arrangement in the VR space.

Examples of the arrangement information include the information on the number of viewing regions (number of images) to be arranged in the VR space, the viewing angle of the entire viewing region, the viewing angle of each viewing region, the direction of each viewing region in the VR space (the location in the VR space), the number of overlap areas, the viewing angle of each overlap area, the direction (position) of each overlap area in the VR space, etc. For example, the arrangement information may be stored in a header portion of a live-action image file. Alternatively, the arrangement information may be stored as the information in association with the live-action image as a separate file from the file (data) of the live-action image.

Incidentally, on the assumption that the display of the VR image (video) of the present embodiment is normalized (standardized) in advance and that a normalized live-action image in conformity with the standard is used, it is not necessary to store the above-described detailed arrangement information with and in relation to the plurality of live-action images to be displayed. Namely, in the case where the number of viewing regions (number of images) to be arranged in the VR space, the viewing angle of the entire viewing region, the viewing angle of each viewing region, the direction of each viewing region in the VR space (the location in the VR space), the number of overlap areas, the viewing angle of each overlap area, the direction (position) of each overlap area in the VR space, etc. are stipulated in advance as a standard, the image arrangement unit 321 can arrange each live action image in the VR space based on the information on the above standard.

Furthermore, for example, a plurality of standards may be set such as a first standard having a viewing angle of the entire viewing region of 180 degrees, a second standard of 220 degrees, a third standard of 270 degrees, a fourth standard of 360 degrees, etc. In this case, it is only necessary that the standard information, indicating which standard, each image to be displayed is in conformity with, is associated with the image. In this case, each standard information is an example of the above-described “arrangement information”.

Furthermore, the above standard may have a certain degree of freedom. For example, only some items of the above-described arrangement information may be standardized, while other items are set arbitrarily or changeable. Specifically, for example, it may be arranged such that the viewing angle of the entire viewing region is standardized and defined beforehand, while the number of viewing region, (the number of images) arranged in the VR space, the viewing angle of each viewing region, and the like are set arbitrarily. In this case, it is only necessary that as “the arrangement information”, the contents of the standard information and the arbitrary setting items are associated with the image of a target of display.

The image generation unit 32 includes a switch unit 322. The switch unit 322 has a function of dynamically switching the live-action image displayed in the overlap area between the adjacent live-action images based on the viewing direction defined by the viewing direction specifying unit 31. Based on the viewing direction, the switch unit 322 dynamically switches the live-action image to be displayed in the overlap area between the adjacent live-action images so that the region boundary of the adjacent real-action images moves away from the viewing direction.

Here, the configuration wherein “the configuration wherein based on the viewing direction, between adjacent live-action images, a live-action image to be displayed in the overlap area is dynamically switched” is defined such that between the two adjacent live-action images (the first image and the second image) that can be displayed in the overlap area, which one of the live-action image is to be displayed in the overlap area is specified each time based on the viewing direction, and the live-action image to be displayed in the overlap area is dynamically switched according to changes in the viewing direction.

As illustrated in FIG. 10 to FIG. 12, one example of “the configuration wherein based on the viewing direction, a live-action image to be displayed in the overlap area is dynamically switched between adjacent live-action images” includes a configuration wherein the reference direction RD is set, and based on which adjacent images of the first image and the second image are switched in such a manner that when the viewing direction S is on the first image side of the reference direction RD, the image to be displayed in the overlap area AO is switched to the first image, and when the viewing direction S is on the second image side of the reference direction RD, it is switched to the second image.

Furthermore, it may be configured such that the live-action image to be displayed in the overlap area is switched dynamically between the adjacent live-action images based on the viewing direction without setting the reference direction. For example, as illustrated in FIG. 13, it may be configured such that with reference to the current region boundary (BD1 or BD2) of the adjacent live-action images (the first image and the second image), the first image is displayed in the overlap area AO when the viewing direction S is on the first image side of the current region boundary, and the second image is displayed in the overlap area AO when the viewing direction S is on the second image side of the current region boundary. This configuration is one example of the configuration wherein based on the viewing direction, a live-action image to be displayed in the overlap area is dynamically switched between adjacent live-action images “. As another example of the configuration wherein based on the viewing direction, a live-action image to be displayed in the overlap area is dynamically switched between adjacent live-action images”, it may be configured such that when the viewing direction becomes closer to the current region boundary between the adjacent live-action images than a predetermined distance or less (when the angle between the viewing direction and the region boundary becomes less than the predetermined degrees), the live-action image currently displayed in the overlap area is switched to the other live-action image.

Furthermore, for the process of “switching the live-action images displayed in the overlap area”, for example, in the overlap area, two adjacent live-action images are arranged in different layers (image layers) in the up-and-down direction. Then, the transparency of the live-action image arranged in a lower layer (background) remains unchanged (0%), and the transparency of the live-action image arranged in the upper layer (foreground) is switched to either 100% or 0%. Namely, when displaying the live-action image in the lower layer in the overlap area, the transparency of the upper layer is set to 100%, and when the live-action image in the upper layer is displayed, the transparency of the upper layer is set to 0%. As described, the configuration wherein in the overlap area, two adjacent live-action images are arranged respectively in different layers in the up-and-down direction, and the transparency of the live-action images in the upper layer is switched to either 100% or 0% is one example configuration of “switching the live-action images displayed in the overlap area”.

Furthermore, it may be configured such that two adjacent live-action images are arranged so as to be superimposed in the overlap area, and the transparency of one of the two live-action images is set to 0% and the transparency of the other live-action image is set to 100% to switch the transparency according to the live-action image to be displayed, as one example configuration of “switching the live-action images displayed in the overlap area”.

Furthermore, instead of superimposing the two adjacent live-action images in the overlap area, it may be configured such that only the part corresponding to the overlap area of the live-action image displayed is arranged in the overlap area, and the live-action image to be arranged is switched, as one example of “switching the live-action images displayed in the overlap area”.

Here, a switch period for switching the live-action images in the overlap area can be set arbitrarily. The switch period may be set to approximately zero to instantly switch the live-action images, or may be set to a predetermined period (for example, 0.3 seconds, etc.). Furthermore, when switching between the live-action images in the overlap area, there may be a period during which both adjacent live-action images are displayed, for example, as translucent composite images.

Furthermore, the image generation unit 32 (the switching unit 322 of the image generation unit 32) sets a reference direction to a predetermined direction from the virtual viewpoint, and has a function of defining a live-action image to be displayed in the overlap area based on the viewing direction with respect to the reference direction. Here, “the reference direction” is a direction set in relation to the viewing direction to determine whether or not to switch the live-action image displayed in the overlap area. “The reference direction” can be set to a predetermined direction from the virtual viewpoint in the VR space, and may be set to any direction as long as it is within the viewing region where the adjacent live-action images are arranged in the VR space. For example, as illustrated in FIG. 10 and FIG. 11, the direction RD passing from the virtual viewpoint P in the VR space through the center of the overlap area AO corresponds to an example of the “reference direction”. The “reference direction” may be fixed, or may be changed (the predetermined direction changes) to be described later.

For example, as illustrated in FIG. 10, when the viewing direction S is on the left side of the reference direction RD (the viewing region A1 side of the first image), the image generation unit 32 defines the live-action image to be displayed in the overlap area AO to be the first image. On the other hand, as illustrated in FIG. 11, when the viewing direction S is on the right side of the reference direction RD (the viewing region A2 side of the second image), the image generation unit 32 identifies the live-action image to be displayed in the overlap area AO to be the second image.

It is preferable that the image generation unit 32 (the switch unit 322 of the image generation unit 32) sets the reference direction to a direction of a predetermined position in the overlap area from the virtual viewpoint. Here, “to set the reference direction to the direction of a predetermined position in the overlap area from the virtual viewpoint” is defined “to set the reference direction in the overlap area (to set the reference direction so that a vector indicating the reference direction exists in the overlap area). In this case, as illustrated in FIG. 10 and FIG. 11, the reference direction RD is set in the overlap area AO. Therefore, even when the viewing direction S is to the direction of the region boundary (BD1 or BD2) of the overlap area AO, the live-action image to be displayed in the overlap area AO is switched before the viewing direction reaches the region boundary, and therefore the region boundary is also moved away from the viewing direction S.

Further, the image generation unit 32 obtains the detection information regarding the orientation of the HMD 10. Based on the detection information, the image generation unit 32 has a function of changing the range of the VR image to be displayed on the display unit 11 of the HMD 10. For example, based on a result of detection by the sensor 12, such as the angular rate sensor built in the HMD 10, etc., the image generation unit 32 changes the viewing direction from the virtual viewpoint P in the VR space, and changes the range of the VR image displayed on the display unit 11 of the HMD 10. The image generation unit 32 changes, for example, the range of the VR image displayed on the display unit 11 of the HMD 10 according to the orientation of the HMD 10 using the visual axis of the HMD 10 as the viewing direction.

### 6. PROCESSING

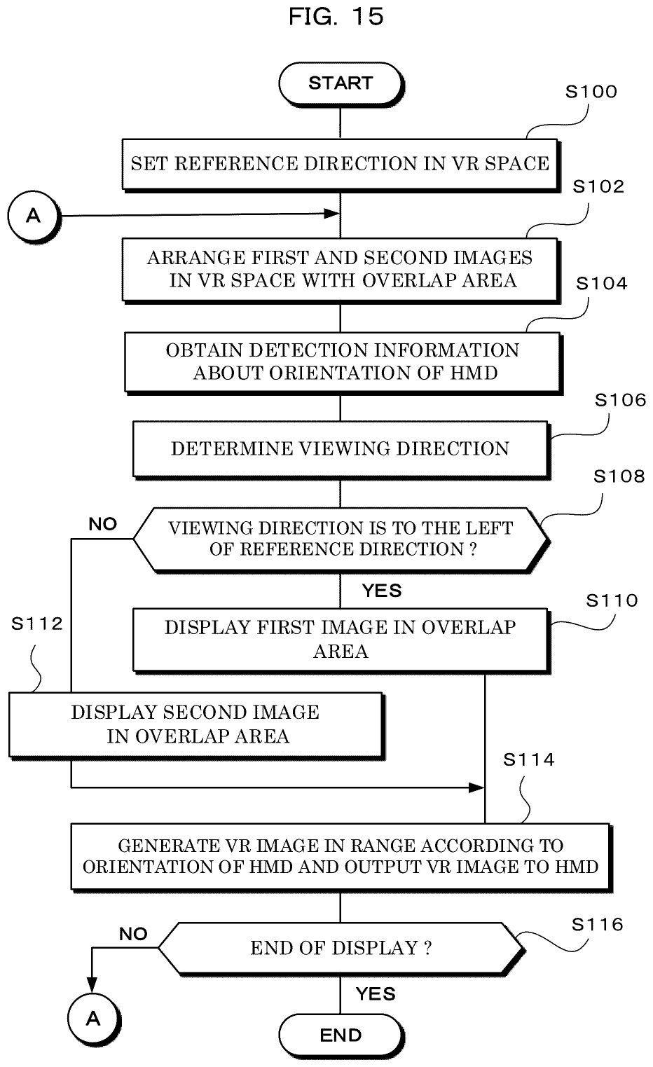

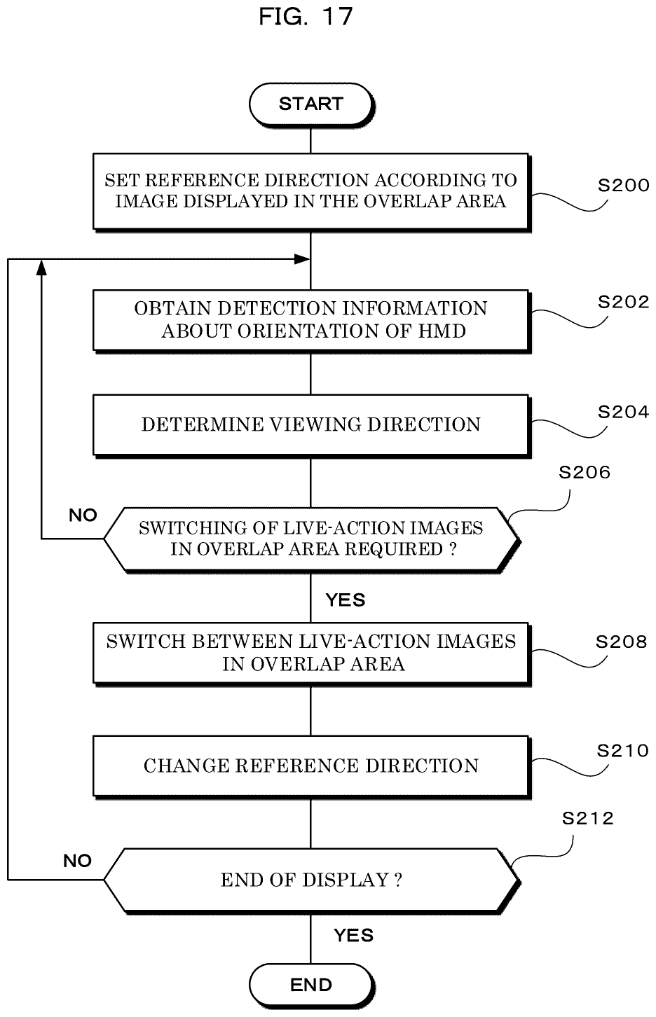

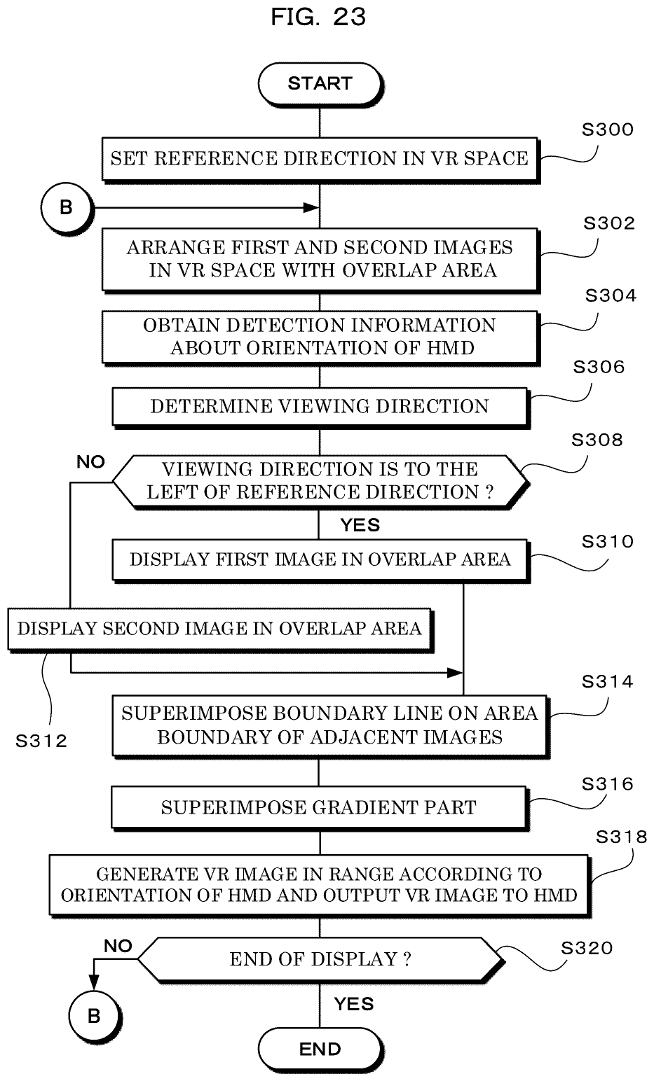

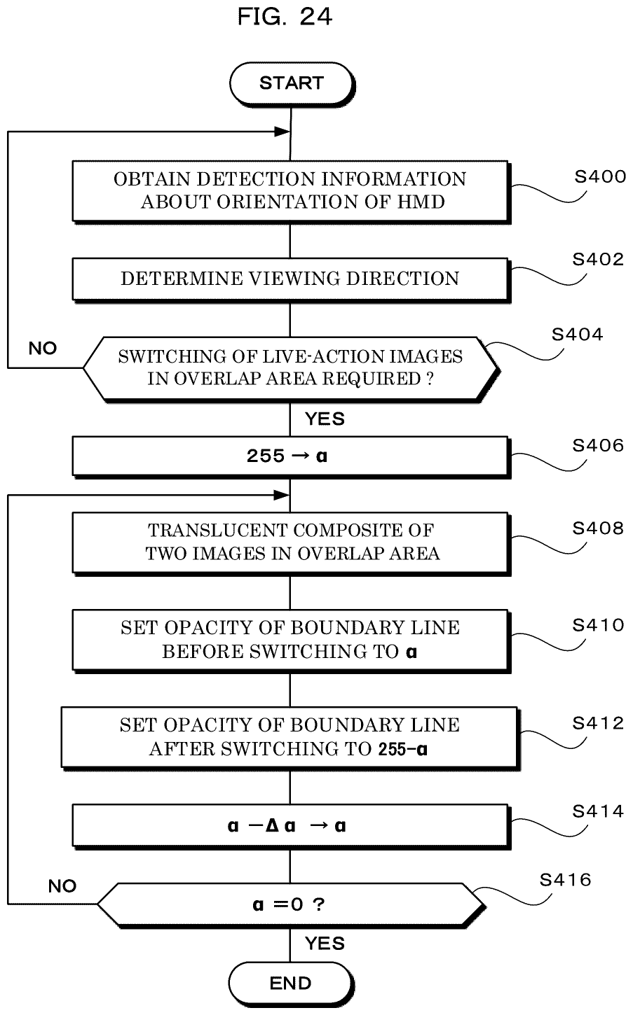

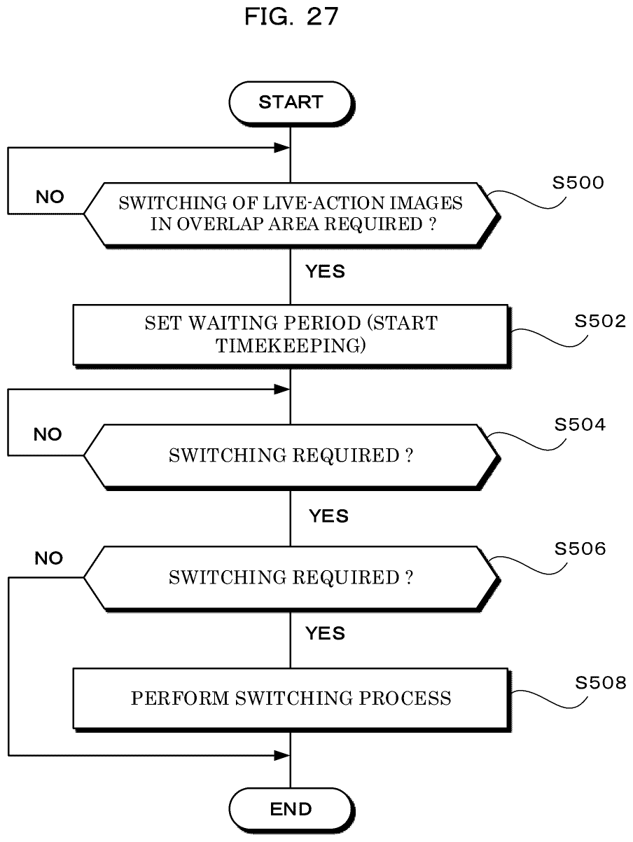

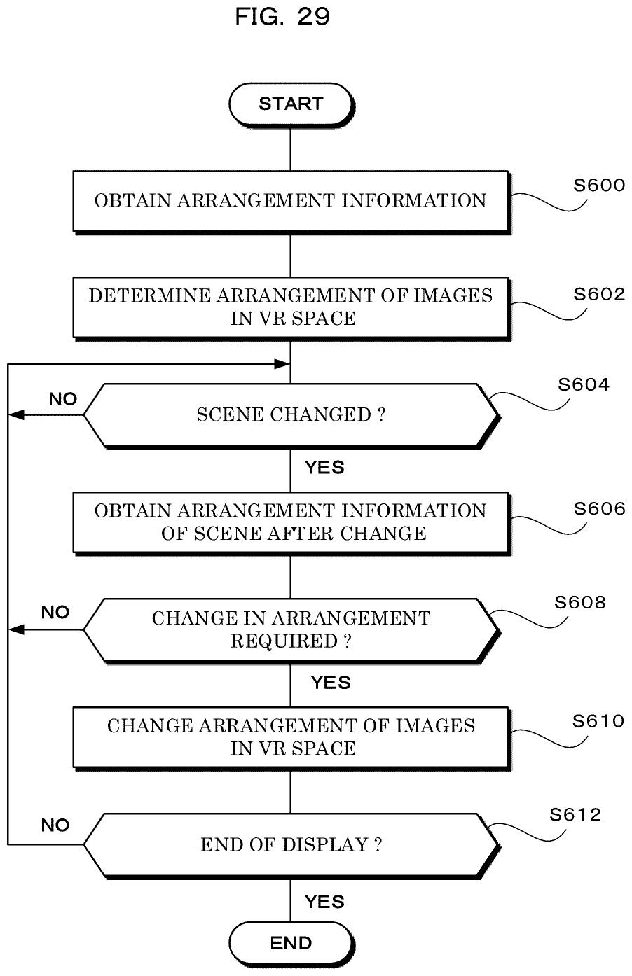

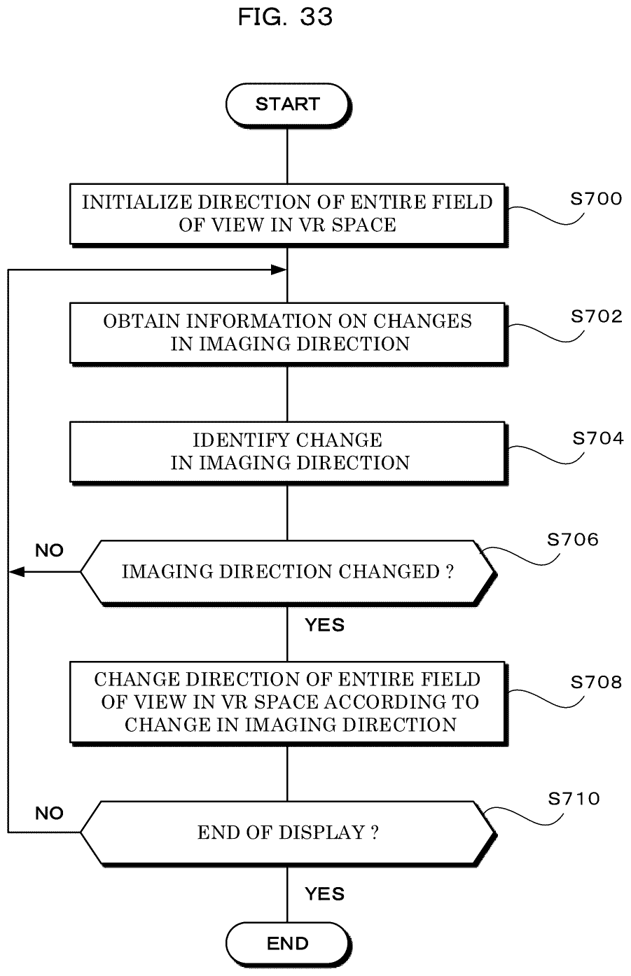

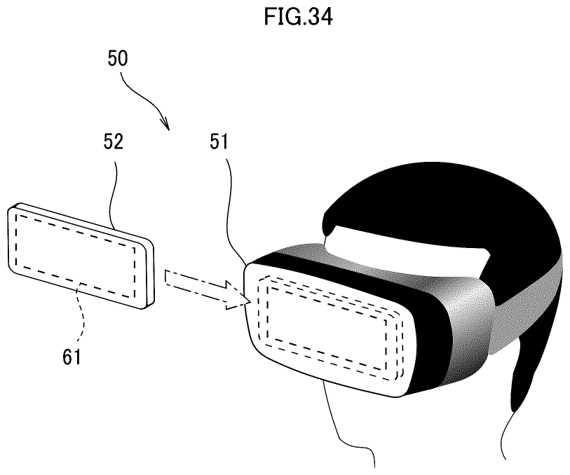

Next, an example of the processing performed by the display control device 20 of the present embodiment will be described below. FIG. 15 is a flowchart illustrating an example of the processing of the display control device 20. The below-explained processing is realized by the control unit 30 (the processor 21 of the display control device 20) which executes a program stored in the storage device 22 (The same can be applied to the processing in reference to each of the flowcharts of FIG. 17, FIG. 23, FIG. 24, FIG. 27, FIG. 29 or FIG. 33).

Here, one example of the display control processing of the VR image will be explained which have been explained with reference to FIG. 9 to FIG. 12.

As illustrated in FIG. 10, FIG. 12, etc., the control unit 30 sets the reference direction RD in the VR space V (S100). The data of the live-action images (the first image and the second image) captured by two cameras having different imaging directions for capturing the real space is stored, for example, in the storage device 22 or the recording medium and the like. The control unit 30 reads out the first image, the second image, and the arrangement information from the storage device 22 and the like. Then, based on the arrangement information, the control unit 30 arranges the first image and the second image in the VR space V so that the overlap area AO exists in which the respective viewing regions A1 and A2 of the first image and the second image partially overlap with each other (S102). For example, the control unit 30 arranges the first image and the second image respectively in different layers in the up-and-down direction in the overlap area AO. For example, the first image is arranged in the lower layer and the second image is arranged in the upper layer.

Further, the control unit 30 obtains the detection information regarding the orientation of the HMD 10 from the sensor 12 (for example, the angular rate sensor) of the HMD 10 (S104) and defines the viewing direction S (S106). Then, the control unit 30 determines whether or not the viewing direction S is to the left (the first image side) of the reference direction RD (S108), and if YES in S108, the first image is displayed in the overlap area AO as illustrated in the example of FIG. 10 (S110). For example, the first image can be displayed in the overlap area AO in the configuration wherein the transparency of the first image is fixed at 0%, and the transparency of the second image, arranged in the upper layer than the layer of the first image is arranged, is set to 100%. On the other hand, when the viewing direction S is to the right (the second image side) of the reference direction RD (NO in S108), the control unit 30 displays the second image in the overlap area AO as illustrated in the example of FIG. 11 (S112). For example, the second image can be displayed in the overlap area AO by setting the transparency of the second image to 0%, arranged in the upper layer of the layer of the first image. As described, the control unit 30 executes the control of dynamically switching the live-action image displayed in the overlap area AO between the adjacent real-action images (the first image and the second image) based on the viewing direction S.

Then, the control unit 30 generates a VR image in a range corresponding to the orientation of the HMD 10 based on the detection information regarding the orientation of the HMD 10 in S104, and outputs the VR image as generated to the HMD 10 (S114). For example, the control unit 30 outputs the VR image generated by performing a rendering process or the like to the HMD 10. As a result, the VR image is displayed on the HMD 10.

The processing of S102 to S114 is repeated until the display is terminated by a user's playback stop operation or the like (YES in S116).

### 7. EMBODIMENT OF CHANGING REFERENCE DIRECTION

In the foregoing explanations, descriptions have been given through the case where the fixed reference direction RD is set. However, with the fixed reference direction RD, when the visual axis direction (the viewing direction S) of the HMD 10 exists in a vicinity of the reference direction RD, the live-action image displayed in the overlap area AO may be switched frequently, which makes it difficult for users to see the image. In consideration of this problem, it may be configured such that the reference direction RD is changed at the timing of switching the real-action image to be displayed in the overlap area AO, so that the reference direction RD is moved away from the visual axis direction (the viewing direction S) of the HMD 10. This will be described below.

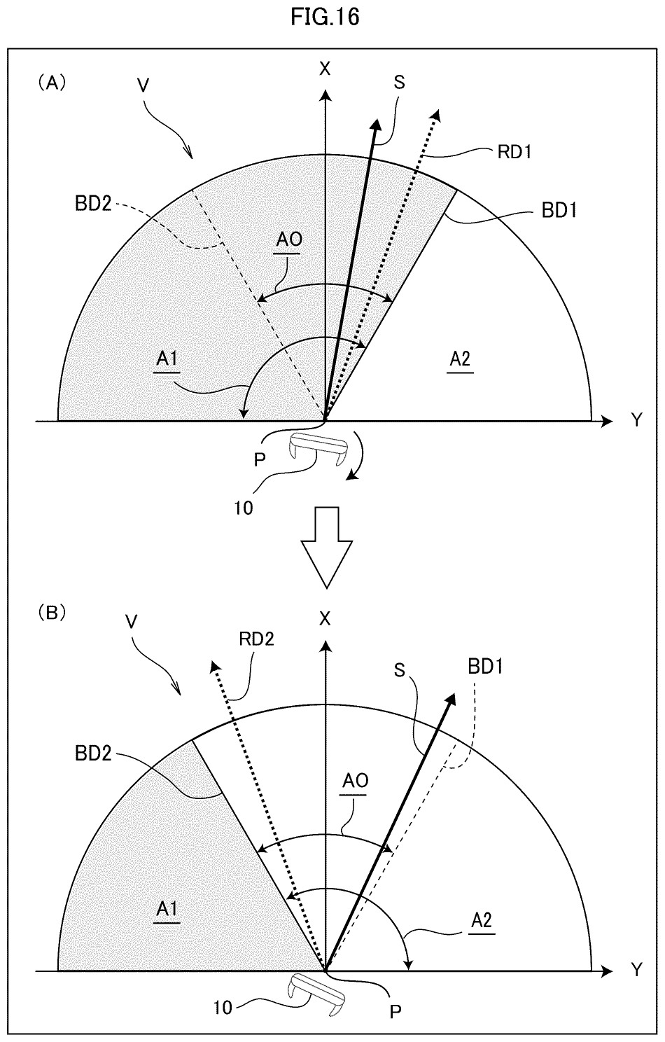

As illustrated in the example (A) of FIG. 16, when the first image of the viewing region A1 on the left side is displayed in the overlap area AO, the reference direction RD1 is set in a direction shifted to the right (for example, minus 20 degrees) of the direction from the virtual viewpoint P passing through the center of the overlap area AO. Here, the angle in the counterclockwise direction is defined to be the positive direction. From this state, when the visual axis direction (the viewing direction S) of the HMD 10 rotates in the clockwise direction beyond the reference direction RD1, as illustrated in the example (B) of FIG. 16, the live-action image displayed in the overlap area AO is switched from the first image to the second image in the viewing region A2. At this timing of switching (at the same time of switching), the reference direction is moved to the left to be away from the visual axis direction (the viewing direction S) of the HMD 10, and the reference direction RD1 in (A) of FIG. 16 is changed to the reference direction RD2 in (B) of FIG. 16. Namely, as illustrated in the example (B) of FIG. 16, when the second image of the viewing region A2 on the right side is displayed in the overlap area AO, the reference direction RD is set in a direction shifted to the left (for example, 20 degrees) of the direction from the virtual viewpoint P passing through the center of the overlap area AO.

Furthermore, from the state (B) of FIG. 16, when the visual axis direction (the viewing direction S) of the HMD 10 rotates in the left direction, and exceeds the reference direction RD2, as shown in (A) of FIG. 16, the live-action image displayed in the overlap area AO is switched from the second image to the first image in the viewing region A1, and at the same time, the reference direction RD2 is changed to the reference direction RD1. Here, at the same time, can be substantially at the same time.

This is the modification wherein the reference direction (RD1 or RD2) is changed at the timing when the live-action image to be displayed in the overlap area AO is switched to perform hysteresis control. Further, in this modification, when the live-action image displayed in the overlap area AO is switched, the reference direction RD is moved toward the region boundary (BD1 or BD2) after being switched, so that the reference direction is moved away from the viewing direction S. Furthermore, in this modification, the reference direction (RD1 or RD2) is changed according to the live-action image displayed in the overlap area AO (depending on whether it is the first image in the viewing region A1 or the second image in the viewing region A2).

The image generation unit 32 has a function of changing the reference direction (RD1 or RD2) at the timing of switching the live-action images to be displayed in the overlap area AO according to the live-action image to be displayed in the overlap area AO (depending on whether it is the first image in the viewing region A1 or the second image in the viewing region A2).

Next, with reference to FIG. 17, an example of the above-described process of changing the reference direction will be explained. FIG. 17 is a flowchart illustrating an example of the process for changing the reference direction executed by the control unit 30 according to the present embodiment.

As illustrated in the example of (A) or (B) of FIG. 16, the control unit 30 sets the reference direction (RD1 or RD2) according to the live-action image (the first image of the viewing region A1 or the second image of the viewing region A2) displayed in the overlap area AO (S200). Further, the control unit 30 obtains the detection information on the orientation of the HMD 10 from the sensor 12 (for example, an angular rate sensor) of the HMD 10 (S202) and defines the viewing direction S (S204). Further, the control unit 30 determines whether it is necessary to switch the live-action images displayed in the overlap area AO based on the viewing direction S with respect to the current reference direction (RD1 or RD2) (S206). If YES in S206, the control unit 30 executes the process of switching the live-action images displayed in the overlap area AO (S208) and changes the reference direction to a direction corresponding to the live action image as switched (S210). On the other hand, if NO in S206, the process moves back to S202. The processes of S202 to S210 are repeated until the display is terminated by a user's reproduction stop operation, or the like (YES in S212).

According to the foregoing embodiment, the reference direction (RD1 or RD2) is not fixed, but is changed according to the live-action image displayed in the overlap area AO at the timing of switching the live-action images displayed in the overlap area AO. In this way, since the reference direction is temporarily moved away from the viewing direction S after the live-action image is switched, it is possible to reduce the frequency of switching of the live-action image displayed in the overlap area AO.

### 8. Embodiment of Visibly Displaying Current Region Boundary

The image display system 1 of the present embodiment is configured such that by switching the live-action images (the first image or the second image) displayed in the overlap area AO, the region boundary (BD1 or BD2) of the adjacent live-action images is kept away from the viewing direction S. However, as will be explained below, it may be configured to purposely make the current region boundary visible.

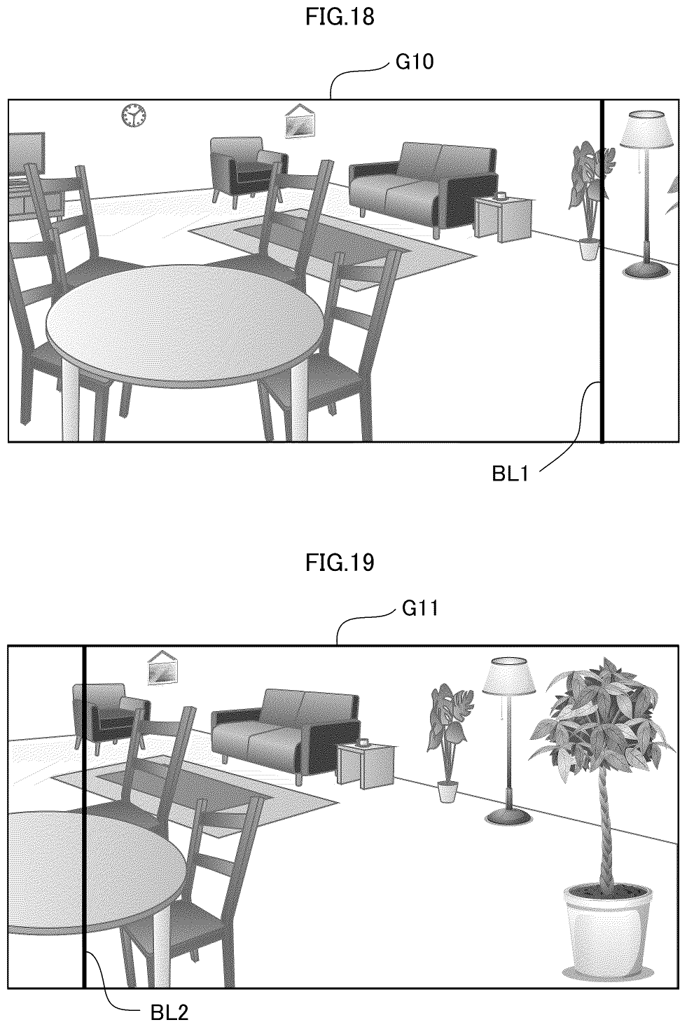

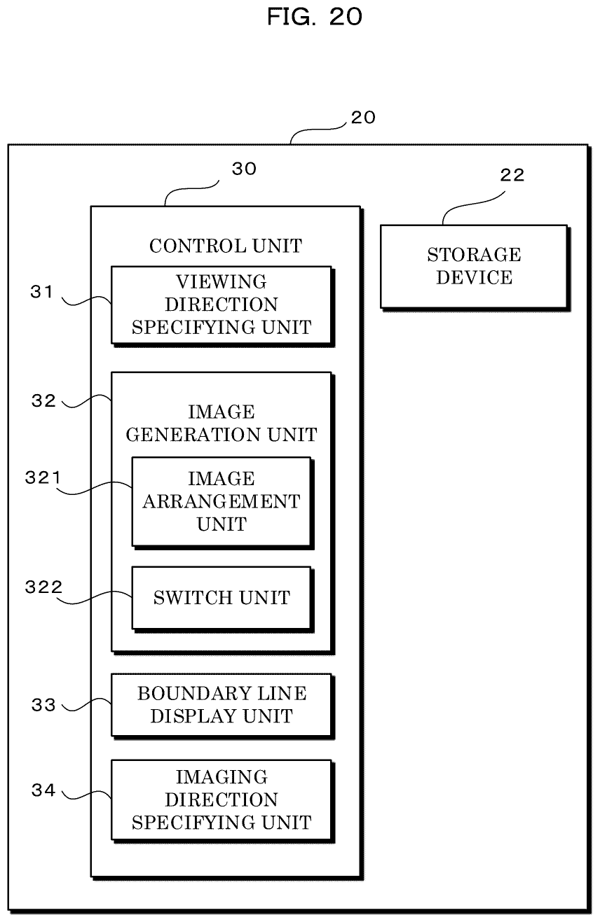

FIG. 18 and FIG. 19 are diagrams illustrating examples of a screen displayed in the display unit 11 of the HMD 10. On the screen G10 illustrated in the example of FIG. 18, displayed is a VR image in the view field range according to the orientation of the HMD 10 in the VR space V illustrated in the example of FIG. 10. Namely, on the screen G10, displayed is a VR image showing the view field in the visual axis direction (the viewing direction S) of the HMD 10 from the virtual viewpoint P in the VR space V of FIG. 10. Therefore, the first image of the viewing region A1 on the left side is displayed in the overlap area AO. On this screen G10, the boundary line BL1 is visibly displayed at a portion corresponding to the current region boundary BD1 (the right end of the overlap area AO) between the adjacent live-action images (the first image and the second image). The boundary line BL1 is, for example, a black solid line with a user-recognizable line width.

A screen displayed when a user looking at the screen G10 of FIG. 18 rotates his/her head (HMD 10) in the right direction is the screen G11 illustrated in the example of FIG. 19. On this screen G11, displayed is a VR image in a view field range according to the orientation of the HMD 10 in the VR space V illustrated in the example of FIG. 11. Namely, since the visual axis direction (the viewing direction S) of the HMD 10 rotates to the right beyond the reference direction RD, the VR image displayed in the overlap area AO is switched from the VR image on the screen G10 of FIG. 18 to the VR image on the screen G11 illustrated in the example of FIG. 11. On this screen G11, the boundary line BL2 is visibly displayed at a portion corresponding to the current region boundary BD2 (the left end of the overlap area AO) between the adjacent live-action images (the first image and the second image). The boundary line BL2 is, for example, a black solid line with the same line width as the boundary line BL1.

As illustrated in the example of FIG. 20, the display control device 20 may include a boundary line display unit 33. The boundary line display unit 33 has a function of displaying a boundary line which is visible to a user in the region boundary between the adjacent live-action images. Here, “the region boundary between adjacent live-action images” refers to the boundary between the two adjacent live-action images (the first image and the second image) arranged in the VR space. As illustrated in FIG. 10 and FIG. 11, the position of the region boundary (BD1 or BD2) changes depending on the live-action image (the first image of the viewing region A1 or the second image of the view area A2) displayed in the overlap area AO. Further, the term “boundary line” refers to a line displayed on the region boundary so that the user can recognize the region boundary between the adjacent live-action images. The color, the line width, the transparency, etc. of “the boundary line” can be set arbitrarily. Further, the type of the line for “the boundary line” can be arbitrarily set, such as a solid line, a dotted line, a dash-dash line, a wavy line, a double line, or the like. Further, “the boundary line” may be a two-dimensional line or a three-dimensional raised line.

The boundary line display unit 33 arranges the boundary line (BL1 or BL2) on the current region boundary (BD1 or BD2), so that the live-action VR image having the boundary line superimposed thereon is displayed in the display unit 11.

As illustrated in the examples of FIG. 10 and FIG. 11, the region boundary (BD1 or BD2) on which the seam (misalignment) of the images exists is changed by switching the live-action images to be displayed in the overlap area AO based on the viewing direction S. Namely, it is possible for the user to change as desired the region boundary (BD1 or BD2) on which the seam (misalignment) of the images appears by changing the viewing direction S. Namely, even when a seam of the images exists in the direction the user desires to see the image, the seam of the image in the direction the user desires to see can be eliminated by changing the viewing direction S as desired, and it is possible to realize a legible image for the user without the seam.

Then, according to the present embodiment, the boundary line (BL1 or BL2) is displayed, which is purposely made visible, on the region boundary (BD1 or BD2) between the adjacent live-action images, so that the user can recognize the region boundary with ease which appears in the seam (misalignment) of the image. As illustrated in the examples of FIG. 18 and FIG. 19, the boundary line (BL1 or BL2) at the seam part of the image can be changed by changing the viewing direction S as desired by the user, and also after the boundary line is moved, the user can recognize with ease where the seam part of the image is moved. That is, with the foregoing configuration wherein the boundary line (BL1 or BL2) is visibly displayed on the region boundary (BD1 or BD2), it is possible for the user to determine which of the live-action images is to be displayed in the overlap area AO between the adjacent live-action images so that the boundary line is not displayed in the direction in which the user desires to see the image.

When the viewing direction S is specified based on the detection information related to the orientation of the HMD 10 (for example, the detection information of the angular rate sensor), it is possible for the user to change the boundary line (BL1 or BL2) by adjusting the direction of the head of the user, on which the HMD 10 is worn, while adjusting the range of the VR image displayed in the display unit 11 of the HMD 10.

Furthermore, when the viewing direction S is defined based on the detection information (for example, detection information by eye tracking) related to the user's line of sight, it is possible for the user to change the boundary line (BL1 or BL2) displayed on the region boundary (BD1 or BD2) simply by changing the line of sight without moving the head. For example, in the configuration wherein the range of the VR image displayed on the display unit 11 is changed based on the detection information related to the orientation of the HMD 10 (for example, the detection information of the angular velocity sensor), and the viewing direction S is specified based on the detection information related to the user's line of sight (for example, the detection information by eye tracking), it is possible for the user by himself/herself to adjust an image which is easy to see in the following manner. That is, the user adjusts the range of the VR image by adjusting the direction of the user's head, so that the image which the user desires to see can be displayed in the display unit 11 of the HMD 10. Then, even when the boundary line exits in the direction the user desires to see, by adjusting the direction of the user's line of sight to change the boundary (BL1 or BL2) in the state the image which the user desires to see is displayed on the display unit 11, it is possible to display an image that is easy to see.

Incidentally, in the configuration wherein the range of the VR image displayed in the display unit 11 is changed based on the detection information regarding the user's line of sight by eye tracking or the like, and the live-action image displayed in the overlap area AO is switched, it is possible for the user to adjust an image that is easy to see by himself/herself simply by adjusting his or her direction of sight.

### [Display Additional Information on or in Vicinity of Boundary Line]

Next, the following will explain a configuration which further facilitates the user's determination of which live-action image should be displayed and viewed in the overlap area AO between the adjacent live-action images.

For example, the screen G10 of FIG. 18 displays the boundary line BL1; however, it is difficult for the user to immediately recognize whether the overlap area AO is on the left side or the right side of the boundary line BL1. It is also difficult for the user to immediately recognize which of the adjacent live-action images (the first image on the left or the second image on the right) is currently displayed in the overlap area AO. Furthermore, to cause the switching of the live-action image in the overlap area AO (that is, the changing the boundary line), it is difficult for the user to immediately recognize in which direction the viewing direction S should be changed.

Here, even when it is difficult to immediately recognize the above matters, by changing the viewing direction S to the left or to the right, the user becomes able to recognize the above matters, as the screen changes from the screen G10 of FIG. 18 to the screen G11 of FIG. 19, or from the screen G11 of FIG. 19 to the screen G10 of FIG. 18. In this embodiment, an additional information is displayed on or in a vicinity of the boundary line to make it easier for the user to recognize in which direction the viewing direction S should be changed.

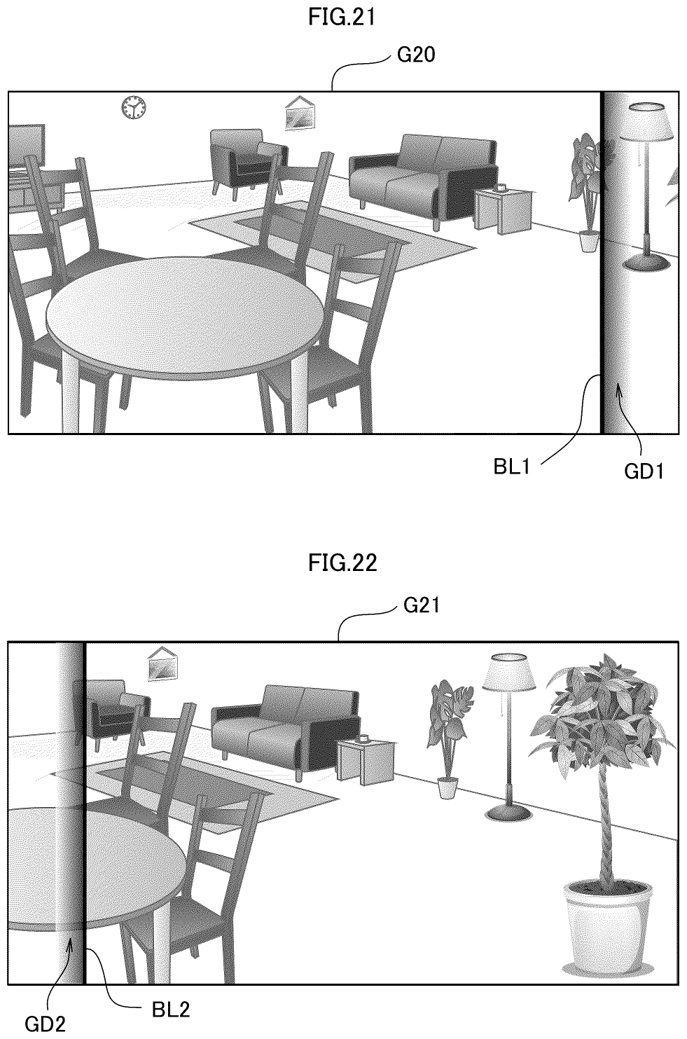

FIG. 21 and FIG. 22 are diagrams illustrating examples of a screen in which a gradient part is displayed together with the boundary line. FIG. 21 illustrates a screen G20 corresponding to the screen G10 of FIG. 18, which is an example of a screen in which a gradient part GD1 is displayed as an additional information on the right side of the boundary line BL1.

The screen G20 of FIG. 21 corresponds to the VR space V of FIG. 10. Therefore, the left side of the boundary line BL1 corresponds to “the overlap area AO in which the first image of the viewing region A1 on the left side is displayed”, and the area on the right side of the boundary line BL1 is not the side of the overlap area AO (an area of only the viewing region A2 on the right side). That is, the gradient part GD1 of the screen G20 is displayed on the opposite side of the overlap area AO having the boundary line BL1 in between. The gradient part GD1 is a translucent area of black color gradient in which a color density or an opacity is reduced gradually or stepwise as being away from the boundary line BL1 (toward the right in FIG. 21). The width (distance in an orthogonal direction to the boundary line BL1), etc., of the gradient part GD1 can be set arbitrarily (the same applies to the gradient part GD2).

FIG. 22 illustrates a screen G21 corresponding to the screen G11 of FIG. 19, which is an example of a screen in which a gradient part GD2 is displayed as an additional information on the left side of the boundary line BL2. The screen G21 of FIG. 22 corresponds to the VR space V of FIG. 11. Therefore, the right side of the boundary line BL2 corresponds to “the overlap area AO in which the second image of the viewing region A2 on the right side is displayed”, and the area on the left side of the boundary line BL2 is not the side of the overlap area AO (an area of only the viewing region A1 on the left side). That is, the gradient part GD2 of the screen G21 is displayed on the opposite side of the overlap area AO having the boundary line BL2 in between. The gradient part GD2 is a translucent area in which a color density or an opacity is reduced gradually or stepwise as being away from the boundary line BL2 (toward the left in FIG. 22). The color of the gradient part GD2 is, for example, a black gradation, but an arbitrary color can be set.

As described, the gradient part (GD1 or GD2) is displayed on the opposite side of the overlap area AO having the boundary line (BL1 or BL2) in between. In this way, a user can recognize that the opposite side of the gradient part (GD1 or GD2) of the boundary line (BL1 or BL2) (on the left side of the boundary line BL1 in FIG. 21, on the right side of the boundary line BL2 in FIG. 22) is the overlap area AO. Also, the user can recognize that in the overlap area AO, currently displayed is the live-action image (the first image on the left side in FIG. 21, the second image on the right side in FIG. 22) on the opposite side of the gradient part (GD1 or GD2) having the boundary line (BL1 or BL2) in between. Furthermore, the user can intuitively recognize that the switching of the live-action image in the overlap area AO (that is, the changing the boundary line) occurs by moving the viewing direction S in the direction the color of the gradient part (GD1 or GD2) becomes lighter (from the boundary line BL1 to the gradient part).

Namely, the gradient part (GD1 or GD2) corresponds to the “information indicating which side of the boundary line is the overlap area”, the “information indicating which of the adjacent live-action images is to be displayed in the overlap area”, or the “information indicating in which direction, the viewing direction should be changed to cause a switching of the live-action image in the overlap area”.

Additionally, since the gradient part (GD1 or GD2) is displayed in a state superimposed on a misalignment part of the image generated on the boundary line (BL1 or BL2), an effect of making the misalignment of the images less conspicuous also occurs. Furthermore, the change in the density or opacity of the gradient part (GD1 or GD2) naturally indicates the direction of changing the viewing direction S necessary for the switching of the live-action image in the overlap area AO. Therefore, as one example of the preferable embodiment, the gradient part (GD1 or GD2) is adopted as the additional information to be displayed together with the boundary line.

Since it is sufficient as long as which side of the boundary line (BL1 or BL2) is the overlap area AO can be recognized, the gradient part (GD1 or GD2) may be displayed on the side of the overlap area AO having the boundary line (BL1 or BL2) in between.

The boundary line display unit 33 of this aspect has a function of displaying an additional information indicating which side of the boundary line is the overlap area on or in a vicinity of the boundary line. Here, the “additional information indicating which side of the boundary line is the overlap area” is an additional information of the boundary line displayed on or in a vicinity of the boundary line, and an information which enables a user to recognize currently which side of the boundary line is the overlap area. For example, as described above, the gradient part (GD1 or GD2) displayed on the opposite side of the overlap area AO (or the side of the overlap area AO) having the boundary line (BL1 or BL2) in between is one example of the “additional information indicating which side of the boundary line is the overlap area”. Note that the additional information is not limited to the gradient part (GD1 or GD2). For example, an “arrow” or a “symbol” indicating which side of the boundary line is the overlap area may be displayed on or in a vicinity of the boundary line. In this case, the “arrow” or the “symbol” corresponds to one example of the additional information.

Incidentally, an additional information such as the “arrow” or the “symbol” is also an example of the “information indicating which of the adjacent live-action images is displayed in the overlap area” or the “information indicating in which direction the viewing direction should be changed to cause the switching of the live-action image in the overlap area”.

The boundary line display unit 33 arranges the boundary line (BD1 or BD2) in the part of the current region boundary (BD1 or BD2), and arranges an additional information such as the above-described gradient part (GD1 or GD2), in such a manner that the boundary line and the additional information are displayed on the display unit 11 so as to be superimposed on the live-action VR image.

Next, with reference to FIG. 23, an example of a procedure of displaying the above-described boundary line (BL1 or BL2) will be explained. FIG. 23 is a flowchart illustrating an example of the processing of the display control device 20 when displaying the boundary line. In the flowchart of FIG. 23, the processes in S300 to S312 are the same as those of S100 to S112 of the flowchart of FIG. 15, and a detailed description of each process is omitted.

The control unit 30 executes a control of dynamically switching the live-action image to be displayed in the overlap area AO between the adjacent live-action images (the first image and the second image) based on the viewing direction S (S304 to S312). Then, the control unit 30 superimposes the boundary line (BL1 or BL2) on a part of the region boundary (BD1 or BD2) between the adjacent live-action images (S314). Further, the control unit 30 superimposes the gradient part (GD1 or GD2), for example, on an area on the opposite side of the overlap area AO (the area of the live-action image that is not displayed in the overlap area AO) having the boundary line (BL1 or BL2) in between (S316). Then, the control unit 30 generates a VR image in a range corresponding to the orientation of the HMD 10 and outputs the VR image as generated to the HMD 10 (S318). Thereby, the VR image including the boundary line (BL1 or BL2) and the gradient part (GD1 or GD2) is displayed on the HMD 10. The processes of S302˜S318 are repeated until the display is terminated (YES in S320).

In the flowchart of FIG. 23, when the gradient part (GD1 or GD2) is not displayed on the VR image, the process of S316 can be omitted.

### [Different Display Modes Between Two Boundary Lines]

The boundary line display unit 33 may be configured to display in different modes the boundary line BL1 displayed on the region boundary BD1 at one end (the right end) of the overlap area AO, and the boundary line BL2 displayed on the region boundary BD2 at the other end (the left end) of the overlap area AO. Here, the configuration of “displaying the boundary lines in different modes” refer to adopt different colors, densities, transparencies, line widths, types of line (solid, dotted, etc.), or adopt different dimensions (two-dimensional or three-dimensional line), etc.

Thereby, when a plurality of images arranged in a horizontal direction are used to expand the horizontal viewing angle, a user can recognize whether the currently displayed boundary line (BL1 or BD2) is a part of a misalignment of images at the left end of the overlap area AO or a part of a misalignment of an image at the right end of the image. Similarly, when a plurality of images arranged in a vertical direction are used to expand the vertical viewing angle, the user can recognize whether the currently displayed boundary line (BL1 or BD2) is a part of a misalignment of images at the upper end of the overlap area AO or a part of a misalignment of an image at a lower end of the image. In this configuration, the display of additional information such as the above-described gradient parts GD1 and GD2 may be omitted, or the additional information may be displayed together with the boundary lines.

### [Providing Setting Switching Period]

When switching between the two live-action images in the overlap area AO, instead of instantly switching from one to the other, a switching period of for example, 0.3 seconds, etc. may be provided, and the switching may be performed gradually over time. For example, when switching the live-action images displayed in the overlap area AO from one to the other, the display of the overlap area AO may be crossfaded in the switching period. Thereby, the boundary line (BL1 or BL2) can be made visible more naturally before and after the switching of the live-action image in the overlap area AO. This will be explained below.

The image generation unit 32 of this embodiment has a function of gradually switching from one live-action image to the other live-action image over time when switching the live-action image displayed in the overlap area AO. Here, “gradually switching from one live-action image to the other live-action image over time” refers that a switching period of, for example, 0.3 seconds, etc., is provided from the start to the end of the switching process, and the live-action image (the first image or the second image) currently displayed in the overlap area AO is gradually switched to the other live-action image over time in the switching period. The length of the switching period can be set arbitrarily.

For example, the configuration wherein the live-action image displayed in the overlap area is gradually switched from one to the other by compositing the target two live-action images to be displayed in the overlap area in the switching period corresponds to one example of “gradually switching from one live-action image to the other over time”. One example of the image composition is alpha blending (translucent composition). More specifically, it may be configured such that the transparency of one live-action image is gradually increased from “0% to 100%” while the transparency of the other live-action image is gradually reduced from “100% to 0%” over time to alpha-blend the two live-action images. Further, it may be configured to arrange, for example, the adjacent two live-action images in different layers in a vertical direction. Then, the transparency of the live-action image arranged in the lower layer (background) remains unchanged at 0%, and the transparency of the live-action image arranged in the upper layer (foreground) is gradually changed over time from 0% to 100% or from 100% to 0% in the switching period. For example, when switching from the live-action image in the upper layer to the live-action image in the lower layer, the transparency of the live-action image of the upper layer is gradually changed over time from 0% to 100% in the switching period. Similarly, when switching from the live-action image in the lower layer to the live-action image in the upper layer, the transparency of the live-action image in the upper layer is gradually changed over time from 100% to 0% in the switching period.

Further, executing the process of gradually replacing the pixels of the live-action image currently displayed in the overlap area with the pixels of the other live-action image in the switching period corresponds to one example of “gradually switching from one live-action image to the other live-action image over time”. In other words, the number of pixels (area) of the live-action image currently displayed in the overlap area gradually decreases over time, while the number (area) of the pixels of the other live-action image gradually increases over time corresponds to one example of “gradually switching from one live-action image to the other live-action image over time”. As a specific example, in the switching period, the pixels are gradually replaced from the side of the current region boundary to the side of the region boundary after the switching is completed, so that the region boundary slides (moves gradually). This configuration corresponds to one example of “gradually switching from one live-action image to the other live-action image over time”. The “replacing the pixels” includes the configuration wherein for the two adjacent live-action images arranged in the overlap area respectively in vertically different layers, “switching the transparency of the pixels in the upper from 0% to 100% or from 100% to 0%”. Further, the “replacing the pixel” includes the configuration of changing the transparency of the pixels of one live-action image to be replaced from 0% to 100%, while changing the transparency of the corresponding pixels of the other live-action image to replace from 100% to 0%. Other than the above, it may be configured such that the transparency of the pixels are changed gradually from one to the other of the live-action images from the center to the circumference, or from the circumference to the center of the overlap area, from the left end to the right end or from the right end to the left end of the overlap area, from the upper end to the lower end or from the lower end to the upper end of the overlap area.

Next, with reference to FIG. 24, an example of a procedure in the case of providing the above-explained switching period will be explained. FIG. 24 is a flowchart illustrating an example of a procedure of a progressively switching the live-action image to be displayed in the overlap area of the display control device 20.

The control unit 30 obtains a detection information related to the orientation of the HMD 10 from the sensor 12 (for example, an angular velocity sensor) of the HMD 10 (S400) and specifies the viewing direction S (S402). Further, the control unit 30 determines whether it is necessary to switch the live-action image displayed in the overlap area AO based on the viewing direction S with respect to a current reference direction (RD1 or RD2) (S404). If YES in S404, the control unit 30 initializes a variable a to the initial value “255” (S406). This variable a is an “a value” used for the translucent composition (alpha blending) of the adjacent live-action images (the first image and the second image) arranged in the overlap area AO in step S408, and can take a value of “0 to 255”. Further, the “a value” is used to change the opacity of the boundary line (BL1 or BL2) in steps S410 and S412.

The control unit 30 subtracts the a value by a predetermined amount Aa for each frame, and changes the a value so that it gradually decreases from “255” to “0” over time in the switching period (S414). For example, the switching period is set to a 20-frame period. One frame is, for example, 1/60 second. For example, if the predetermined amount Aa to be subtracted each frame is “13”, the a value gradually changes from “255” to “0” in the switching period of about 0.3 seconds.

In S408, the control unit 30 translucently combines the two live-action images (the first image and the second image) in the overlap area AO. In this case, the control unit 30 sets the alpha value of each pixel of the image displayed in the overlap area AO (referred to as an “image before switching”) to the value of the variable a before switching. Furthermore, in the overlap area AO, the image displayed after switching is referred to as an “image after switching”. Therefore, in the switching period the translucent composition is performed, the pixel value of each pixel in the overlap area AO is set to “the pixel value of the corresponding pixel of the image before switching*α+the pixel value of the corresponding pixel of the image after switching*(255−α)”.

In S410, the control unit 30 sets the opacity of the boundary line before switching to a. Further, in S412, the control unit 30 sets the opacity of the boundary line after switching to (255−α) and superimposes boundary line on the part of the region boundary after switching. Here, the boundary line is completely opaque (transparency=0%) at α=255, the opacity decreases as the a value decreases, and the boundary line becomes completely transparent (transparency=100%) at α=0.

The steps S408 to S414 are repeated until the a value=0 (YES in S416). As a result, for example, the a value gradually changes from “255” to “0” in the switching period of about 0.3 seconds, and in the overlap area AO, the transparency of the image before switching gradually increases, while the transparency of the image after switching gradually decreases. Further, in the switching period, the boundary line before switching and the boundary line after switching are displayed at the same time, and the transparency of the boundary line before switching gradually increases over time in the switching period, while the transparency of the boundary line after switching gradually decreases over time in the switching period. Finally, when the a value becomes “0” (YES in S416), the switching of the image in the overlap area AO is completed. Then, the image after switching is displayed in the overlap area AO, the boundary line before switching disappears from the display, and instead the boundary line after switching is displayed.

In the foregoing, explanations have been given through the case where the boundary line before switching and the boundary line after switching are displayed simultaneously while changing the transparency in the switching period. However, the present invention is not intended to be limited to this. For example, it may be configured such that at the timing the switching process (switching period) of the image in the overlap area AO is started, the boundary line before switching is erased from the display, and at the timing the switching process (switching period) is completed, the boundary line after switching is displayed. In this case, S410 and S412 of FIG. 24 can be omitted. Alternatively, it may be configured such that in the switching process (switching period), the boundary line before switching and the boundary line after switching are displayed with the same transparency (both may be opaque), and when the switching process (switching period) is completed, the boundary line before switching is erased from the display, and instead the boundary line after switching is displayed.

### (Moving Display of Boundary Line in Switching Period)

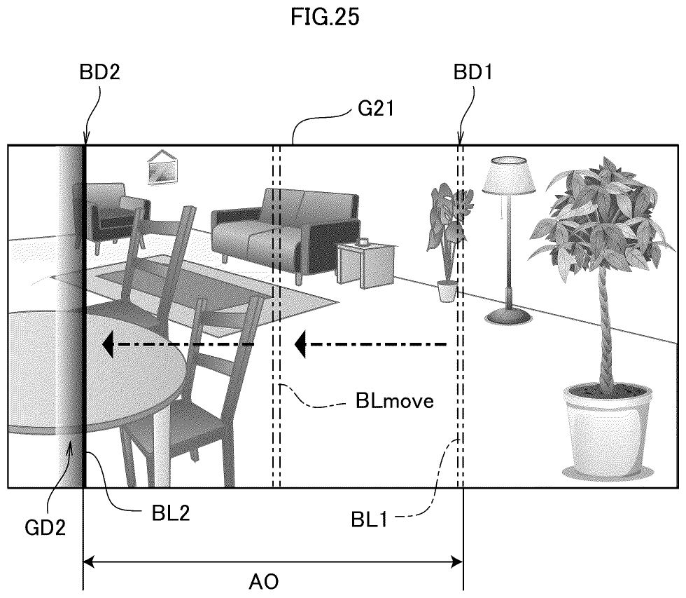

In the embodiment of providing the above-described switching period, the boundary line may be gradually moved to a display position after the switching process is completed in the switching period. For example, in the case where the first image in the viewing region A1 on the left side is displayed in the overlap area AO, the boundary line BL1 is displayed on the screen G20 as illustrated in FIG. 21. From this state, when the live-action image displayed in the overlap area AO is switched to the second image of the viewing region A2 on the right side, as illustrated in FIG. 25, the boundary line BL1 at the position indicated by the dotted line is changed to the position of the boundary line BL2. When switching the image, the display control is performed such that in the switching period (for example, 0.3 seconds, etc.), the boundary line is horizontally moved gradually from the position of BL1 indicated by the dotted line to the position of BL2. Even in this way, the user can recognize the position of the boundary line naturally.

When switching the live-action image displayed in the overlap area AO, the image generation unit 32 of this embodiment has a function of gradually switching from one live-action image to the other while gradually moving the boundary line to the display position after the switching is completed.

For example, the case where the live-action image in the overlap area AO is switched from the first image on the left side to the second image on the right side will be described. As illustrated in the example of FIG. 25, in the switching period, the boundary BLmove is gradually moved horizontally from the region boundary BD1 before switching to the region boundary BD2 after the switching is completed. At this time, in the overlap area AO, in the area on the right side of the boundary line BLmove after being moved (the area between the region boundary BD1 before switching and the boundary line BLmove after moving), respective pixels of the first image are replaced with respective pixels of the corresponding second image. As a result, each pixel of the first image on the right side of the boundary line BLmove in the overlap area AO is switched to the corresponding each pixel of the second image as the boundary line BLmove moves horizontally to the left. This process is repeated until the boundary line BLmove reaches the region boundary BD2 after the switching is completed. The boundary line BLmove stops moving when it reaches the region boundary BD2, to be displayed as the boundary line BL2.

The same process as described above is executed also in the case of switching the live-action image in the overlap area AO from the second image on the right side to the first image on the left side.

As illustrated in FIG. 25, when the gradient part (GD1 or GD2) is displayed as additional information, the display of the gradient part may be controlled as follows. For example, the gradient part (GD1 or GD2) is erased at the timing when the switching process (switching period) of the live-action image in the overlap area AO is started, and the gradient part is displayed when the switching process (switching period) is completed. Alternatively, the gradient part may also be moved along with the movement of the boundary line BLmove.

In addition, in the configuration wherein the boundary line is displayed as being moved over time in the switching period, the switching process of the live-action image in the overlap area AO is not limited to the above. For example, while the switching process of the live-action image in the overlap area AO is performed by the above-described translucent composition (alpha blending), the boundary line may be gradually moved toward the display position after the switching is completed over time in the switching process.

### 9. ONE EXAMPLE OF DIVIDING ENTIRE VIEWING REGION IN THE VR SPACE INTO THREE OR MORE AREAS

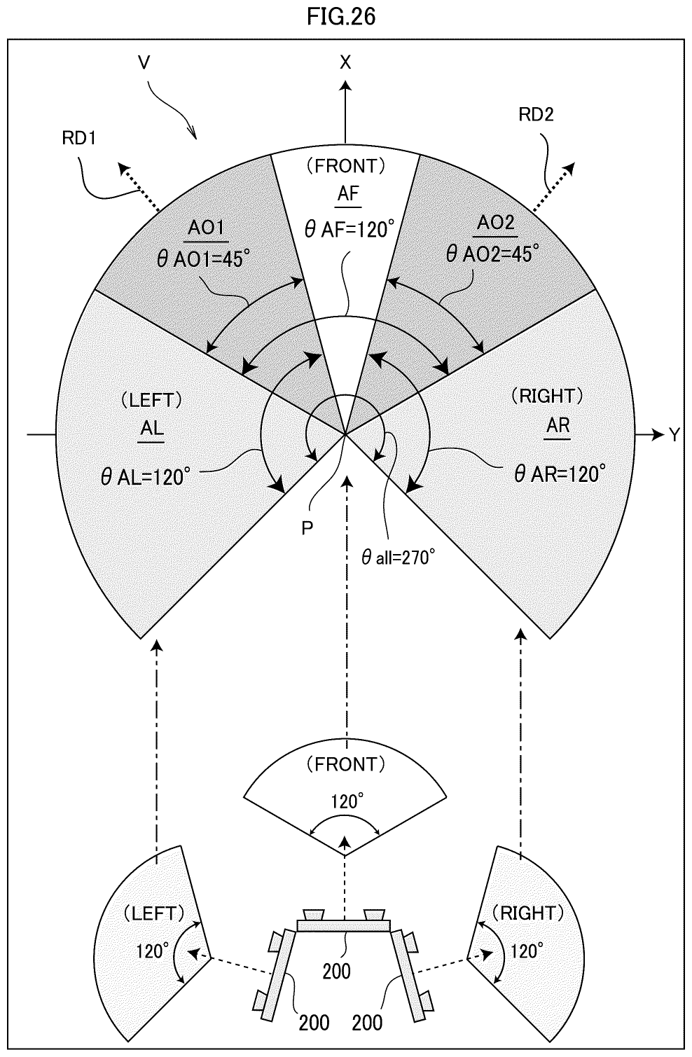

Here, with reference to FIG. 26, as one example, a configuration wherein an entire viewing region in the VR space V is divided into three regions of a left region, a front region, and a right region will be described. Here, explained is an example configuration enabling a reproduction of a high viewing angle image with a horizontal viewing angle of 270 degrees. In this configuration, left, front, and right images are used which are captured by three stereo cameras with a horizontal viewing angle of 120 degrees, which respectively capture images in the left, the front, and the right directions.

FIG. 26 is a diagram conceptually illustrating an example in which a left viewing region AL of a left image, a front viewing region AF of a front image, and a right viewing region AR of a right image are arranged in a VR space V. In the VR space V, the arrangement of the images is controlled so as to generate a first overlap area AO1 in which the left viewing region AL of the left image and the front viewing region AF of the front image overlap each other. Further, the arrangement of the images is controlled so as to generate a second overlap area AO2 in which the front viewing region AF of the front image and the right viewing region AR of the right image overlap each other. In this configuration, a viewing angle θall of an entire viewing region of the VR space Vis 270 degrees, a viewing angle θAL of the left viewing region AL is 120 degrees, a viewing angle θAF of the front viewing region AF is 120 degrees, a viewing angle θAR of the right viewing region AR is 120 degrees, a viewing angle AO10 of the first overlap area AO1 is 45 degrees, and a viewing angle θAO2 of the second overlap area AO2 is 45 degrees.

Further, the reference direction RD1 as a reference for switching the live-action image (the left image or the front image) in the first overlap area AO1 is set in the direction from the virtual viewpoint P to the center of the first overlap area AO1. Further, the reference direction RD2 as a reference for switching the live-action image (the front image or the right image) in the second overlap area AO2 is set in the direction from the virtual viewpoint P to the center of the second overlap area AO2. This is merely one example, and the viewing angle of the entire viewing region, the viewing angle of the viewing region of each image, the viewing angle of each overlap area, with or without the reference direction, the direction of the reference direction can be arbitrarily set.

As in the above example, when the entire viewing region of the VR space is divided into three regions, formed are two overlap areas of the first overlap area AO1 and the second overlap area AO2. In this case, for each of the first overlap area AO1 and the second overlap area AO2, each process related to the above-described overlap area (and the process shown below) may be executed. That is, in the relationship between the left viewing region AL of the left image and the front viewing region AF of the front image adjacent to the left image, the left image corresponds to the “first image”, the front image corresponds to the “second image”, and the first overlap area AO1 corresponds to the above-described “overlap area AO” respectively. Therefore, the above-described processes can be applied. Further, in the relationship between the front viewing region AF of the front image and the right viewing region AR of the right image adjacent to the front image, the front image corresponds to the aforementioned “first image”, the right image corresponds to the aforementioned “second image”, and the second overlap area AO2 corresponds to the aforementioned “overlap area AO”. Therefore, the above-described processes can be applied.

The same can be applied in the case of dividing the entire viewing region of the VR space into four or more regions. In the case of arranging n live-action images captured by n cameras (n is a natural number of not less than 2) in the VR space, (n−1) overlap areas are generated. When there are a plurality of overlap areas AO, one of the adjacent images arranged in respective overlap areas may be considered as the “first image” and the other as the “second image”, and each of the above processes may be applied to each overlap area AO.

Normally, a field-of-view image (VR image) in the range displayed on the display unit 11 of the HMD 10 is a part of the entire viewing region of the VR space. Therefore, when at least one overlap area AO of the plurality of overlap areas is not included in the range of the VR image displayed on the display unit 11, it may be configured that the image switching process, etc., in the overlap area AO not included in the range of the VR image is not performed as such process is unnecessary.

### 10. EMBODIMENT OF PROVIDING TIME LAG BEFORE SWITCHING PROCESS STARTS

In the switching process of the overlap area AO, a predetermined time lag of, for example, 0.5 seconds, etc. may be provided before an execution of the switching process starts. By providing the above time lag, an unnecessary switching process can be omitted. This will be described below.

Here, as illustrated in FIG. 26, explained is an example in which the viewing region of the VR space is constituted by three viewing regions respectively in the left, the front and the right directions. Here, it is assumed that the user wearing the HMD 10 is looking at a VR image in a range including the left viewing region AL and the first overlap area AO1. Then, it is assumed that the left image is currently displayed in the first overlap area AO1. From this state, it is assumed that a user sways his/her head quickly to the right, and with this user's action, the visual axis direction (viewing direction S) of the HMD 10 is instantly moved over the front to the right viewing region AR. In the case without a time lag, both of the switching process in the first overlap area AO1 and the switching process in the second overlap area AO2 may be performed in a short period of time. However, when the visual axis direction of the HMD 10 reaches the right viewing region AR, the first overlap area AO1 may be already moved outside the range of the VR image displayed on the display unit 11 of the HMD 10. Even in the case, if the switching process is executed at an instant reaction, blurring may occur in the VR image displayed on the display unit 11, resulting in lower visibility. On the other hand, in the described case, by providing a time lag in the switching process, it becomes possible to execute only the switching process of the second overlap area AO2 as necessary, and to omit the switching process of the first overlap area AO1. Incidentally, in the case where the first overlap area AO1 and the second overlap area AO2 are not distinguished from one another, both of the overlap areas may be simply described as “the overlap area”.

The image generation unit 32 has a function of providing a predetermined waiting period based on the viewing direction S in a time period from a time a switching of the live-action image displayed in the overlap area AO is determined to a time the switching process starts. Here, this waiting period corresponds to the above-described time lag.

Further, after an elapse of the waiting period before the switching process starts, the image generation unit 32 determines once again whether or not the switching process should be performed, and executes the switching process only when it is determined so.

The waiting period is set to, for example, 0.5 seconds. However, the waiting period is not limited to the above and may be set arbitrarily. Further, different lengths may be set for respective waiting periods between the case where the viewing direction S is specified based on a detection information related to the orientation of the HMD 10 (a detection information of an angular velocity sensor, etc., of the HMD 10) and it is determined whether or not the switching process of the overlap are AO is necessary, and the case where the viewing direction S is specified based on a detection information related to a user's line of sight (a detection information of eye tracking, etc.) and it is determined whether or not the switching process of the overlap are AO is necessary. That is, in the eye tracking, since a line of sight is tracked by analyzing movements of eyes of a person, etc., it is likely that the viewing direction S moves with ease. For this reason, it is preferable to set the waiting period (time lag) longer in the case of the determination based on the eye tracking that tracks the user's line of sight than the case of the determination based on so-called head tracking that detects the orientation of the HMD 10. Namely, in the case where the viewing direction S is specified based on the eye tracking and the switching process is executed, when a user moves his/her eyeballs frequently, the switching process is likely to be executed frequently, and the blurring of the VR image is likely to occur. In response, by setting the waiting time longer, since an unnecessary switching process becomes less likely to occur, it is possible to improve the visibility of the images.

In the case where the HMD 10 has both the head tracking function using an angular velocity sensor, etc., and the eye tracking function, it may be configured such that which of the functions is to be used is selectable for the determination of whether or not the switching process of the overlap area AO is necessary by the user's operation. In this case, the waiting period is changed based on the user's selection.

Next, with reference to FIG. 27, an example of a procedure in the case of providing the above-explained time lag will be explained. FIG. 27 is a flowchart illustrating an example of a procedure of switching the live-action image to be displayed in the overlap area of the display control device 20. The control unit 30 specifies the viewing direction S based on the detection information from the sensor 12 (for example, the angular velocity sensor) of the HMD 10, and determines whether or not it is necessary to switch the live-action image displayed in the overlap area AO (S500). When the control unit 30 determines that the switching process is necessary (YES in S500), the control unit 30 sets a waiting period of, for example, 0.5 seconds and starts time measuring (S502). Then, the control unit 30 does not execute the switching process for the overlap area AO until the waiting period has elapsed. After the waiting period has elapsed (YES in S504), the control unit 30 specifies the viewing direction S again based on the detection information from the sensor 12 of the HMD 10, and determines whether or not it is necessary to switch the live-action image to be displayed in the overlap area AO (S506). When the control unit 30 determines that the switching process is necessary (YES in S506), the control unit 30 executes the switching process (S508). On the other hand, when it is determined that that the switching process is unnecessary (NO in S506), the control unit 30 terminates the process without executing the switching process. For example, in the case where the target overlap area AO is already outside the range of the VR image displayed on the display unit 11 of the HMD 10, the switching process is unnecessary. Another example can be the case where after it is determined that the switching process for the overlap area AO is necessary as the viewing direction S is once moved over the reference direction RD, the viewing direction S is moved back over the reference direction RD to around the original position before the waiting time has elapsed, the switching process is also unnecessary.

### 11. AMENDMENT OF CHANGING ARRANGEMENT OF IMAGES IN VR SPACE

For example, in the examples of FIG. 9 to FIG. 11, the number of the viewing regions (the number of images) arranged in the VR space is 2 (two), and the entire viewing region with a horizontal viewing angle of 180 degrees is constituted by the two viewing regions (a left viewing region and a right viewing region). However, these factors are not fixed, and may be changed depending on a scene, a content, and the like of the image to be displayed. For example, in a game or other content using live-action images, when switching a scene, according to the content of the scene, the number of viewing regions (the number of images) arranged in the VR space, the viewing angle of the entire viewing region, the direction of each viewing region in the VR space (the position in the VR space), and the like may be changed.

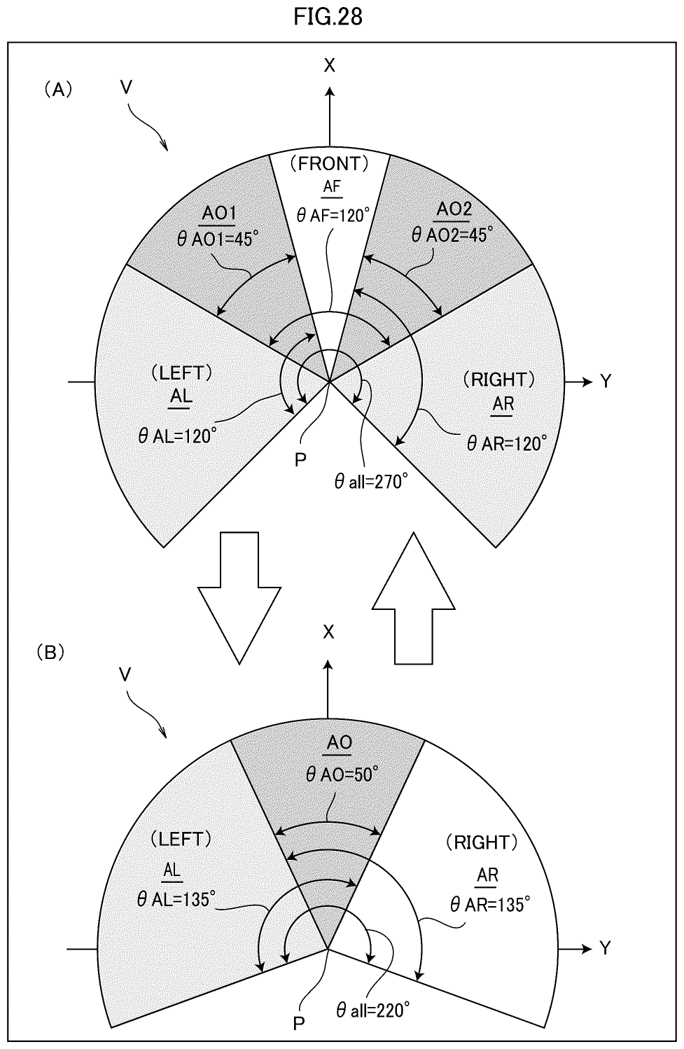

For example, as illustrated in FIG. 28, in some scene, an entire viewing region of 270 degrees is divided into three regions as in the example (A) in FIG. 28, while as illustrated in the example (B) in FIG. 28, an entire viewing region of 220 degrees is divided into two regions. Then, according to a scene, the arrangement (A) or the arrangement (B) is selected. Specifically, for example, in most scenes, the arrangement (A) is basically adopted, while in some scene where only an image in the front area is to be focused, and an image in the rear area is unnecessary, the arrangement (B) is adopted.

In yet another scene, as illustrated in FIG. 9, the entire viewing region of 180 degrees may be divided into two regions. Note that a scene of one area (for example, the entire viewing region is constituted by only one area of 140 degrees) without dividing the entire viewing region may be included in some part.

For example, in one scene, three cameras 200 illustrated in FIG. 26 are used to capture three images arranged in the VR space in the example (A) of FIG. 28. In another scene, only two adjacent cameras 200 may be used out of the three cameras 200 to capture two images arranged in the VR space in the example (B) of FIG. 28.

In this case, the angle of view may be increased (or decreased) by replacing the lens of at least one of the three cameras 200 as necessary, or the imaging direction (the viewing axis direction) of each camera may be adjusted. For example, when switching from an indoor scene to an outdoor scene, or from a scene in one room to a scene in another room, the position of the camera 200 that captures each scene also changes. Therefore, the live-action images can be captured in consideration of the suitable arrangement for each scene in the VR space.

As described above, the arrangement information for arranging the plurality of live-action images in the VR space is stored together with the data of the display target of the plurality of live-action images to be displayed in the storage device 22 in association with the plurality of live-action images. For example, for each scene in which the imaging location of the camera changes in the real space, the above-described arrangement information is generated according to an imaging condition of each scene, and the arrangement information as generated is stored in association with each scene together with the live-action image. Thus, when the arrangement of the plurality of live-action images in the VR space is appropriately changed according to the scene, the arrangement information associated with each scene is stored in the storage device 22. Alternatively, the arrangement information for each scene is recorded in a header of a live-action image file, etc., and the arrangement information is read out and used when the live-action image is reproduced.

The image generation unit 32 of the present embodiment includes an image arrangement unit 321 that changes an arrangement of a plurality of live-action images in the VR space when performing a display control of the display unit 11 displaying the VR image. Here, examples of the targets of change in the arrangement in the VR space include the number of viewing regions arranged in the VR space (the number of images), the viewing angle of the entire viewing region, the viewing angle of each viewing region, the direction (the position) of each viewing region in the VR space, the number of overlap areas, the viewing angle of each overlap area, the direction (the position) of each overlap area in the VR space, and the like. The above information is stored as an arrangement information in association with a plurality of live-action images to be displayed (for example, in association with each scene of a plurality of live-action images).

For example, in the arrangement in the VR space of the example (A) of FIG. 28, the number of viewing regions (the number of images) is 3 (three), the viewing angle of the entire viewing region is “θall=270 degrees”, the direction of the entire viewing region (the position in the VR space) is “−135 degrees to 135 degrees”, the viewing angle of each of a left viewing region AL, a front viewing region AF, and a right viewing region AR is “θAL=θAF=θAR=120 degrees”, a direction of the left viewing region AL is “15 degrees to 135 degrees”, a direction of the front viewing region AF is “−60 degrees to 60 degrees”, a direction of the right viewing region AR is “−135 degrees to −15 degrees”, a viewing angle of the first overlap area AO1 is “θAO1=45 degrees”, a direction of the first overlap area AO1 is “15 degrees to 60 degrees”, a viewing angle of the second overlap area AO2 is “θAO2=45 degrees”, and a direction of the second overlap area AO2 is “−60 to −15 degrees”. All or a part of these information are stored as the arrangement information. Here, the angle in the above direction is an angle in a horizontal direction when the X-axis direction (the reference viewing direction) is set to 0 degrees, and an angle in a vertical direction is omitted here.

Further, in the arrangement of the VR space in the example (B) of FIG. 28, stored as the arrangement information are such information that the number of the viewing regions (the number of images) is 2 (two), the viewing angle of the entire viewing region is “θall=220 degrees”, the direction of the entire viewing region is “−110 degrees to 110 degrees”, and the viewing angles of the left viewing region AL and the right viewing region AR are “θAL=θAR=135 degrees, and (hereinafter omitted).

The image arrangement unit 321 determines whether or not it is necessary to change the arrangement of the plurality of live-action images to be displayed in the VR space based on the arrangement information associated with the plurality of live-action images, and appropriately changes the arrangement based on the arrangement information.

According to the image display system 1 of the present embodiment, as described above, it is not configured that one VR image data completed by the stitching process is prepared beforehand, but configured that the display control of the VR image is executed while arranging the plurality of live-action images in the VR space. Therefore, while the VR image is being reproduced, it is possible to appropriately change the arrangement of the live-action image in the VR space as in the present embodiment. For example, according to the scene, the number of viewing regions (the number of live-action images) arranged in the VR space, the viewing angle of the entire viewing region, etc., can be changed. Namely, it is possible to optimize the VR space for each scene. It is therefore possible to eliminate unnecessary viewing region for each scene, and to reduce the amount of image data.

Furthermore, not only that the data capacity can be reduced by eliminating unnecessary viewing region for each scene, but also the resolution of the VR image displayed on the display unit 11 of the HMD 10 can be increased in the scene in which the unnecessary viewing region is eliminated. That is, since an unnecessary viewing area is eliminated, it is possible to expand VR images of high resolution to VRAM or the like. For example, in the arrangement (B), a VR image having a higher resolution than that in the arrangement (A) of FIG. 28 is displayed on the display unit 11 of the HMD 10. Therefore, in the scene where an image of higher resolution is required, the arrangement (B) of FIG. 28 may be adopted, while in other scenes, the arrangement (A) may be used to optimize the VR space for each scene.

Next, with reference to FIG. 29, an example of a procedure of the present embodiment will be explained. FIG. 29 is a flowchart illustrating an example of a procedure of changing an arrangement of images in the VR space of the display control device 20.

The control unit 30 obtains an arrangement information of the plurality of live-action images to be displayed (S600), and determines the arrangement of the plurality of live-action images in the VR space based on the arrangement information (S602). When reproducing the VR image, the arrangement in the VR space as determined here is applied, and the adjacent live-action mages are arranged in such a manner that the viewing regions are partially overlapped in the overlap area. Further, as described above, based on the viewing direction S (for example, the visual axis direction of the HMD 10), the live-action image to be displayed in the overlap area AO is dynamically switched, and a VR image is generated. When the scene is changed in the reproduction of the VR image (YES in S604), the control unit 30 obtains the arrangement information of the scene as changed (S606), and determines whether or not the arrangement of the image in the VR space should be changed (S608). Here, when the control unit 30 determines that it is necessary to change the arrangement (YES in S608), the control unit 30 changes the arrangement of the plurality of live-action images in the VR space (S610). As a result, after the scene has been changed, a suitable arrangement in the VR space for the scene is applied, and a VR image is generated in which the image of the scene is arranged in the VR space. The processes of S604 to S610 are repeated until the display is terminated (YES in S612).

### 12. CHANGING DIRECTION OF THE ENTIRE VIEWING REGION IN VR SPACE

In the above description, regarding the cameras that capture a plurality of live-action images to be displayed, it has not been considered to change the direction of the camera when imaging. However, the direction of the camera may be changed when imaging. In that case, a change in the imaging direction when imaging may be reflected to a viewing region in the VR space.

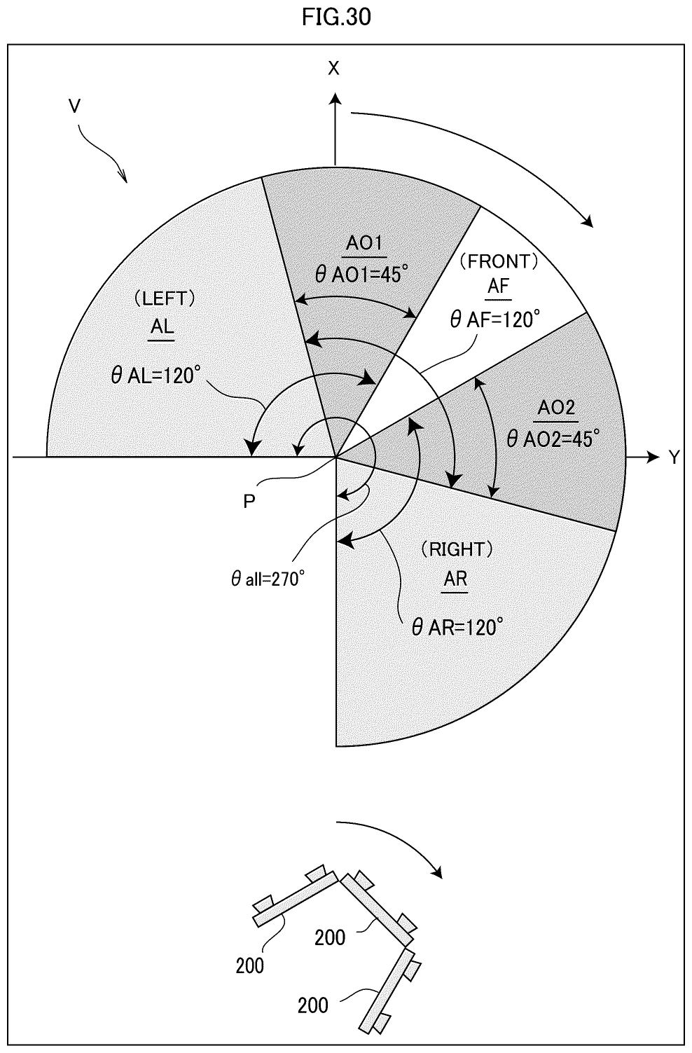

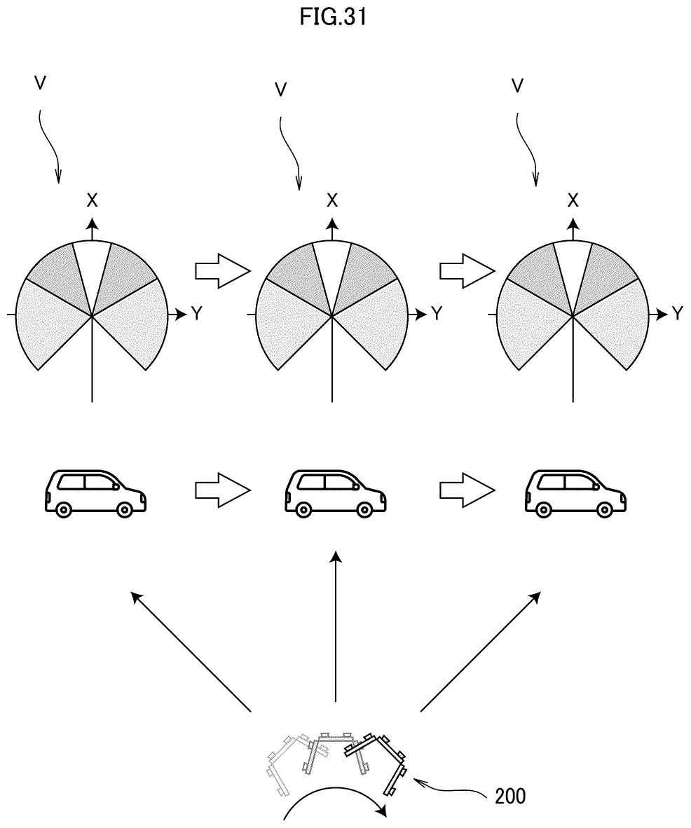

For example, as illustrated in FIG. 26, it is assumed that there is a relationship between the three cameras 200 that capture the real space and the viewing regions in the VR space V in which respective images captured by the three cameras 200 are arranged. The imaging direction of each camera 200 of FIG. 26 is the reference imaging direction of each camera, and the reference imaging direction of the camera 200 at the front corresponds to the X-axis direction (a reference viewing direction) of the VR space V. Here, FIG. 30 illustrates a case where the three cameras 200 of FIG. 26 are rotated in the right direction. As illustrated in FIG. 30, according to changes in direction (rotations of the imaging direction) of the three cameras 200, rotated is the entire viewing region of the VR space V in which the respective images captured by the three cameras 200 are arranged.

In the example of FIG. 26, in the case of an image captured by the camera 200 in a reference imaging direction, a direction of the entire viewing region in the VR space V is “−135 degrees to 135 degrees” when the X axis direction (reference viewing direction) is set to 0 degrees. On the other hand, in the example of FIG. 30, the imaging direction of the camera 200 is rotated by 45 degrees (that is, −45 degrees) to the right from the reference imaging direction of FIG. 26. In the case of an image captured by the camera 200 of FIG. 30, a direction of the entire viewing region in the VR space V rotates 45 degrees to the right to “−180 degrees˜90 degrees”.

An information on a change in the imaging direction of the camera 200 may be detected when imaging from an angular velocity sensor (a gyro sensor) built in the camera 200, and may be stored together with the image data when imaging. Alternatively, after imaging, a change in the imaging direction may be specified by a known image analysis from the captured image, and information of the change in the imaging direction may be stored in association with the captured image. Alternatively, the display control device 20 may specify a change in the imaging direction in real time by the image analysis from the captured image while the image is being reproduced.

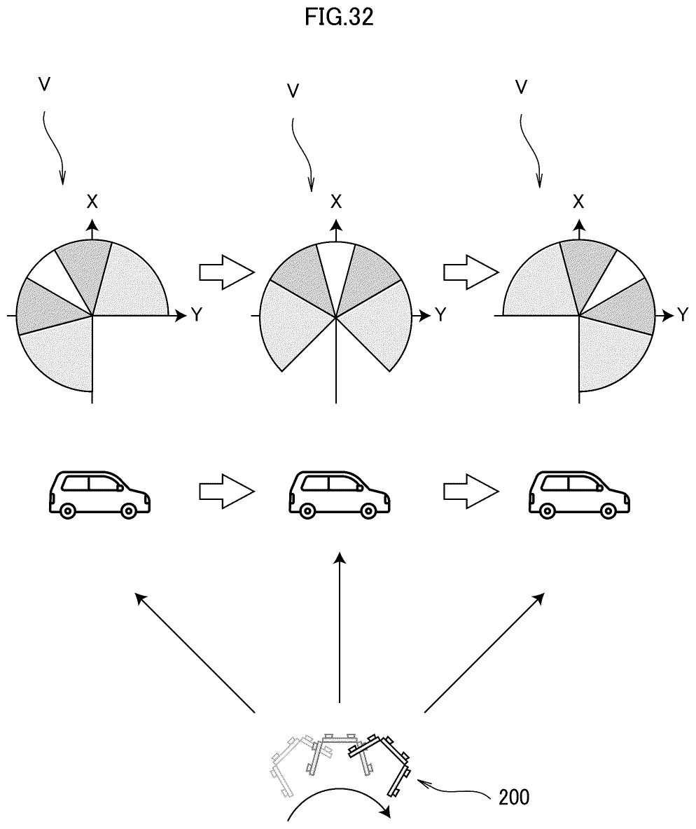

For example, in the real space, in a scene a vehicle passes in front from the left and runs through to the right, considered is the case where the camera is changed its direction from the left to the right as the vehicle moves. FIG. 31 illustrates an example of a change in the viewing region of the VR space Vin which the images captured by the camera 200 are arranged when the information on the rotations of the imaging direction of the camera 200 is not used. When the information on the rotations in the imaging direction is not used, the direction of the entire viewing region does not change when the camera 200 rotates, and the imaging direction of the camera 200 at front always corresponds to the X axis direction of the VR space V. Therefore, when the captured image is displayed on the HMD 10 without using the information on a rotation in the imaging direction, it is possible to display an image of the vehicle without crossing the region boundary of the adjacent images. However, even though the vehicle is moving, the captured image is displayed in the same direction with respect to the visual axis (viewing direction S) of the HMD 10, which is different from reality, and the realistic image cannot be ensured.

FIG. 32 illustrates an example of a change in the viewing region of the VR space V in which the respective images captured by the camera 200 are arranged when the information on the rotation of the imaging direction of the camera 200 is used. When the information on the rotation of the imaging direction is used, the direction of the entire viewing region of the VR space V is also rotated according to the rotation of the imaging direction. In this case, when the captured image is displayed on the HMD 10, an image of the vehicle moving from the left to the right is displayed also with respect to a line-of-sight direction (viewing direction S) of the HMD 10. Therefore, when reproducing the image if the vehicle exists in the left direction, the vehicle cannot be seen unless the user turns the HMD 10 to the left direction (or the vehicle is seen in the left direction when the user is facing forward). By turning the user's head to a direction of the vehicle, the user can see the vehicle clearly, and a realistic VR image can be displayed. In addition, it becomes possible to display an image of the vehicle on the display unit 11 of the HMD 10 without crossing the region boundary (boundary line when displaying the boundary line) of the adjacent images.

As illustrated in FIG. 20, the control unit 30 of the display control device 20 of this aspect may include an imaging direction specifying unit 34. The imaging direction specifying unit 34 has a function of specifying a change in the imaging direction of a plurality of cameras that have imaged a plurality of live-action images. For example, the imaging direction specifying unit 34 can specify a change in the imaging direction by reading out “the information on changes in the imaging directions” stored in association with the plurality of live-action images. Alternatively, the imaging direction specifying unit 34 may specify a change in the imaging direction by the analysis of the image from the live-action image.

The image generation unit 32 has a function of changing the direction of the viewing region (entire viewing region) of the plurality of live-action images arranged in the VR space according to the change in the imaging direction specified by the imaging direction specifying unit 34.

Next, with reference to FIG. 33, an example of a procedure according to the present embodiment will be explained. FIG. 33 is a flowchart illustrating an example of a process for changing the direction of the entire viewing region in the VR space of the display control device 20.

When a reproduction of the VR image starts, the control unit 30 initializes the direction of the entire viewing region in the VR space to the direction corresponding to the reference imaging direction (S700). For example, as illustrated in FIG. 26, a horizontal direction of the entire viewing region is set to “−135 degrees to 135 degrees” by default, and a direction of the center of the front viewing region AF from the virtual viewpoint P is the X-axis direction (the reference viewing direction). Further, the control unit 30 obtains the information on a change in the imaging direction of the plurality of live-action images to be displayed (S702) and specifies the change in the imaging direction (S704). For example, the control unit 30 specifies the change in the imaging direction by reading and obtaining per frame, for example, an information on a change in the imaging direction stored together with the data of a plurality of live-action images to be displayed. Then, when the control unit 30 determines that the imaging direction has changed from the previous frame (YES in S706), the direction of the entire viewing region in the VR space is changed according to the change in the imaging direction (S708). On the other hand, if it is determined that the imaging direction has not changed (NO in S706), the process returns to step S702. The processes of S702 to S708 are repeated until the display is terminated (YES in S710).

### 13. SUMMARY

As described above, a program according to the present embodiment causes the display control device 20, which performs a control for displaying a VR image of a field of vision from a virtual viewpoint in a virtual reality (VR) space (V) as a stereoscopic image using binocular parallax on a display unit 11 of a head mount display 10, to function as the viewing direction specifying unit 31 and the image generation unit 32. The display control device 20 is an example of the computer.

The display control device 20 according to the present embodiment includes the viewing direction specifying unit 31 and the image generation unit 32. The viewing direction specifying unit 31 specifies a viewing direction S that is the direction of the user's line of sight with respect to the VR space. The image generation unit 32 arranges a plurality of live-action images captured by a plurality of cameras having different imaging directions of imaging a real space so that an overlap area occurs in which the viewing regions of the adjacent live-action images partially overlap each other, and generates the VR image according to the viewing direction S. Here, the image generation unit 32 dynamically switches the live-action image displayed in the overlap area AO among the adjacent live-action images based on the viewing direction S.

Here, the “VR image” in this configuration is a stereoscopic live-action image using binocular parallax displayed on the display unit 11 of the HMD 10; however, a display object other than the live-action image may be included in the “VR image”. For example, display objects other than live-action objects, such as CG (Computer Graphics), various objects, lines, symbols, and characters, etc., may also be placed in the VR space, and these objects may be superimposed on the live-action image to generate a “VR image”. The “VR image” includes an AR (Augmented Reality) image or an MR (Mixed Reality) image. The “VR image” may be a still image or a video. The “VR image” may be appropriately converted to a transmission format corresponding to the HMD 10, for example, when it is supplied (transmitted) to the display unit 11 of the HMD 10.

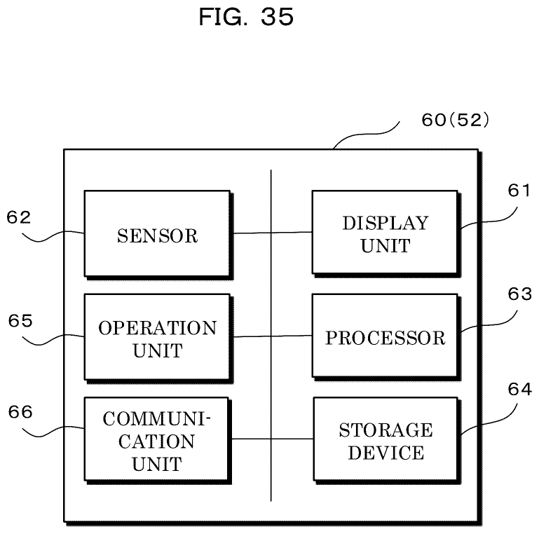

Further, as illustrated in FIG. 34, the “HMD” may be, for example, an HMD 50 including an attachment (mounting device) 51 that can be attached to a user's head and an information processing apparatus 52 such as a smartphone, etc., attached to the attachment 51. In this case, the display unit 61 of the information processing apparatus 52 is a display unit of the HMD 50. Further, the “HMD” may be a so-called stand-alone HMD in which the function of the display control device 20 is integrated with the HMD 10. Further, the “HMD” may be a goggle type or a glasses type that can be worn on the head. Further, the “HMD” is not limited to the HMD in a narrow sense, and includes for example, headphones, a headset (headphones with a microphone), a glasses-type camera, an ear camera, a hat with a camera, or the like having a function as the HMD.

Further, the “display control device” according to the present embodiment can be applied to various devices as long as it has an information processing function such as generating a VR image. The “display control device” may be a stationary or portable game machine, a business use (commercial use) game machine, a personal computer, a tablet computer, a smartphone, a mobile phone terminal, a PHS terminal, a PDA, or a multifunctional television receiver with an information processing function, etc. Further, when the HMD itself has an information processing function such as generating a VR image, the HMD can be a “display control device” of this configuration. For example, as illustrated in FIG. 34, in the case of the HMD 50 including the attachment 51 and the information processing apparatus 52, the information processing apparatus 52 such as a smartphone is an example of the “display control device” according to the present embodiment. Further, a stand-alone HMD is an example of the “display control device” according to the present embodiment.

According to the above configuration, the live-action image to be displayed in the overlap area AO is dynamically switched based on the viewing direction S. In this way, the region boundary (BD1 or BD2) between the adjacent live-action images in the overlap area AO can be moved away from the direction of the user's line of sight. As a result, it it possible to reduce a sense of discomfort of a “seam (misalignment) between adjacent live-action images” which occurs at the region boundary. As described above, in the conventional technique for performing a stitching process, if there is a short distance object at the seam of the images, at or less than a certain distance from the camera (for example, 2 m or less), the stitching process becomes difficult to be performed, and VR image data cannot be generated. In contrast, according to the present embodiment, even in the case where a short distance object at or less than a certain distance from the camera is included in the live-action image, and such short distance object exists in or in the vicinity of the region boundary, it is possible to display a stereoscopic VR image with less sense of discomfort for the user. In other words, a VR image with little discomfort can be displayed no matter where the short distance image object is located in the VR space, and it is possible to realize a VR image display control that enables a close-range display. In addition, since VR images can be generated without requiring the stitching process, it is also possible to reduce the time and effort required to create VR images.

Further, since the stitching process is not required, a VR image with little discomfort in the seams between the live-action images can be displayed on the display unit 11 almost in real time using the live-action image (live video) currently being imaged by the camera.

Further, the image generation unit 32 may be configured such that a reference direction RD is set in a predetermined direction from the virtual viewpoint P, and a live-action image to be displayed in the overlap area AO is specified based on the viewing direction S with respect to the reference direction RD. Thereby, it is possible to realize a switching control of the live-action image to be displayed in the overlap area AO with ease.

Further, the image generation unit 32 may set a reference direction RD in the direction of a predetermined position in the overlap area AO from the virtual viewpoint P. In this way, since the reference direction RD is set in the overlap area AO, even when the viewing direction S is being moved to the region boundary (BD1 or BD2) of the overlap area AO, the live-action image displayed in the overlap area AO is switched before the viewing direction S reaches the region boundary, and therefore, the region boundary is also moved away from the direction of the user's line of sight.

Further, the image generation unit 32 may change the reference direction RD according to the live-action image displayed in the overlap area AO at the timing the live-action image displayed in the overlap area AO is switched. As a result, after the live-action image is switched in the overlap area AO, the reference direction RD is temporarily moved away from the viewing direction S. Therefore, a frequent switching of the live-action image to be displayed in the overlap area AO is less likely to occur.

Further, the image generation unit 32 may specify a live-action image to be displayed in the overlap area AO based on the viewing direction S with respect to the current region boundary (BD1 or BD2) of the adjacent live-action images. Thereby, without setting the reference direction, a switching control of the live-action image displayed in the overlap area AO can be realized with ease. Furthermore, since the reference region boundary is changed at the timing of switching the live-action image displayed in the overlap area AO, as in the foregoing case of changing the reference direction RD, a similar effect can be provided. Namely, a frequent switching of the live-action image to be displayed in the overlap area AO is less likely to occur.

Further, the image generation unit 32 may be configured such that the live-action image currently displayed in the overlap area AO is switched to the other live-action image when the viewing direction S is moved closer to the current region boundary (BD1 or BD2) of the adjacent live-action images at a predetermined distance or closer (for example, when an angle formed by the viewing direction S and the current region boundary becomes a predetermined degrees or smaller). In this case also, without setting the reference direction, a switching control of the live-action image to be displayed in the overlap area AO can be realized with ease. Furthermore, since the live-action image displayed in the overlap area AO is switched before the viewing direction S reaches the region boundary, the region boundary can be moved away from the direction of the user's line of sight.

Further, the viewing direction specifying unit 31 may obtain a detection information (for example, the detection information of an angular velocity sensor) related to the orientation of the HMD 10, and specify the viewing direction S based on the detection information. Thereby, the user can dynamically switch the live-action image displayed in the overlap area AO by changing the orientation of the HMD 10.

Further, the viewing direction specifying unit 31 may obtain a detection information (for example, a detection information of an eye tracking) related to the user's line of sight, and specify the viewing direction S based on the detection information. Thereby, the user can dynamically switch the live-action image to be displayed in the overlap area AO by changing the movement of his/her eyes (a direction of his/her line of sight).

Further, the image generation unit 32 may obtain a detection information related to the orientation of the HMD 10, and based on the detection information, change the range of the VR image displayed on the display unit 11. With this configuration, the range of the VR image displayed on the display unit 11 is changed according to the orientation of the HMD. Further, for the VR image displayed on the display unit 11, a live-action image displayed in the overlap area AO is dynamically switched based on the viewing direction S. Here, when the viewing direction S is specified based on the detection information on the orientation of the HMD 10, by adjusting the orientation of the HMD 10, the user can dynamically switch the live-action image displayed in the overlap area AO while changing the range of the VR image displayed on the display unit 11. Further, when the viewing direction S is specified based on detection information (for example, an eye tracking detection information) related to the user's line of sight, by changing the orientation of the HMD 10, the user adjusts the range of the VR image displayed on the display unit 11 and changes the movement of his/her eyes (the direction of his/her line of sight), thereby dynamically switching the live-action image to be displayed in the overlap area AO.

Further, the display control device 20 may include a boundary line display unit 33. The boundary line display unit 33 displays a boundary line (BL1 or BL1) visible to the user on the region boundary (BD1 or BD2) between the adjacent live-action images. As described, since the boundary line is visibly displayed on the region boundary, the user can recognize the region boundary in which the seam (misalignment) of the image occurs with ease. It can facilitate the user's determination of which live-action image between the adjacent live-action images should be displayed and viewed in the overlap area to prevent the boundary line from appearing in the direction the user desires to see.

Further, the boundary line display unit 33 may differ the type of display of the boundary line (BL1 or BL2) displayed at the region boundary (BD1 or BD2) at one end of the overlap area AO from the type of display of the boundary line displayed in the region boundary at the other end. As a result, the user can recognize whether the currently displayed boundary line is a misalignment part of the image at one end of the overlap area (for example, the left end) or a part of the image at the other end (for example, the right edge).

Further, the boundary line display unit 33 may display an additional information (for example, a gradient part (GD1 or GD2)) at or around the boundary line (BL1 or BL1) to indicate on which side of the boundary line, the overlap area AO exists. As described, with the configuration wherein the user can recognize which side of the boundary line, the overlap area exists, the user can determine with ease in which direction the viewing direction S is to be changed to switch the live-action image displayed in the overlap area AO.

The additional information is superimposed on the live-action image near the boundary line (BL1, BL2), and includes a translucent gradient part (GD1, GD2) in which a color density or an opacity is reduced gradually or stepwise as being away from the boundary line. This gradient part provides the effect of hiding and making a misalignment of the image occurred near the boundary line (BL1 or BL2) inconspicuous. In addition, a change (a change from dark to thin or from thin to dark) in the density or opacity of the gradient part (GD1 or GD2) serves to naturally indicate the direction of the necessary change of the viewing direction S for switching the live-action image in the overlap area AO.

Further, when switching the live-action image displayed in the overlap area AO, the image generation unit 32 may gradually switch from one live-action image to the other live-action image over time. For example, in the switching period of, for example, 0.3 seconds, two live-action images to be switched may be alpha-blended and crossfaded. When switching from one live-action mage to the other to be displayed in the overlap area AO, rather than switching suddenly, by gradually switching over time from the start to the end of the switching period, it is possible to make the boundary line visible more naturally.

Further, when switching the live-action image displayed in the overlap area AO, the image generation unit 32 may gradually switch from one live-action image to the other live-action image while gradually moving the boundary line (BL1 or BL1) toward the display position after the switching is completed according to a lapse of time. As described, in the switching period, by moving the boundary line of the live-action image displayed in the overlap area AO, the user can naturally recognize the position of the boundary line to be changed.

Further, the image generation unit 32 may set a predetermined waiting period after determining based on the viewing direction that the switching process of the live-action image displayed in the overlap area AO should be performed, before the switching process starts. With this configuration, in the case where the viewing direction changes in the waiting period, and the switching process is not needed (for example, after the lapse of the waiting period, the overlap area AO has already moved out of the range of the VR image displayed on the display unit 11 of the HMD 10), an unnecessary switching process can be omitted.

Further, in the case of the HMD 10 having both a head tracking function by an angular velocity sensor, etc., and an eye tracking function, the following configuration may be adopted. That is, the image generation unit 32 may be configured to select either the detection information on the orientation of the HMD 10 or the detection information on the user's line of sight (for example, a detection information of eye tracking) based on the user's selection operation, and specify the viewing direction S based on the detection information as selected. In this case, the waiting period may be changed based on the user's selection. For example, when it is selected to specify the viewing direction S based on the detection information on the user's line of sight, the waiting period may be set longer. Further, since depending on a user, the way of moving his/her head or his/her eyes differs, the waiting period may be arbitrarily set by the user. For example, within a predetermined range (for example, a range of 0.1 seconds to 1.0 seconds), the waiting period may be set by the user. Further, the waiting period in the case of head tracking and the waiting period in the case of eye tracking may be set respectively by the user.

Further, the image generation unit 32 may change the arrangement of the plurality of live-action images in the VR space when performing the display control of the VR image on the display unit 11. The number of viewing regions in the VR space, the direction of the viewing region, etc., may be changed according to the content of the scene. For example, as illustrated in FIG. 28, in one scene, an entire viewing region of 270 degrees may be divided into three regions, and in another scene, for example, the entire viewing region of 220 degrees may be divided into two regions.

According to the display control of the VR image according to the present embodiment, it is not configured such that one VR image data is created by the stitching process as in the conventional configuration, but that the display control of the VR image is executed while arranging the plurality of live-action images in the VR image. Therefore, it is also possible to appropriately change the arrangement of the live-action images in the VR space when reproducing the VR image. For example, as described above, the number of viewing regions (the number of the live-action images) arranged in the VR space and the viewing angle of the entire viewing region can be changed according to the scene. In other words, it is possible to optimize the VR space for each scene. Therefore, it is possible to eliminate unnecessary viewing region for each scene, and the amount of image data can be reduced. Further, in a scene in which an unnecessary viewing region is eliminated, the resolution of the VR image displayed on the display unit 11 of the HMD 10 can be increased.

Further, the display control device 20 may include an imaging direction specifying unit 34. The imaging direction specifying unit 34 specifies a change in the imaging direction of a plurality of cameras that have captured a plurality of live-action images. Then, the image generation unit 32 changes the direction of the viewing region of the entire plurality of live-action images arranged in the VR space according to the change in the imaging direction specified by the imaging direction specifying unit 34. According to this configuration, for example, in the case of a live-action image in which the imaging direction of the camera changes according to the movement of a moving subject (a vehicle, etc.), the direction of the viewing region of the total live-action image arranged in the VR space changes according to the change in the imaging direction. Therefore, the display unit 11 of the HMD 10 can display a realistic VR image in which the subject moves with respect to the viewing direction S. Further, if a live-action image of the subject is prepared so as not to cross the region boundary of the adjacent live-action images when imaging the object according to the movement of the subject, it is possible to reproduce VR images with excellent visibility so that the subject does not cross the region boundary.

### 14. MODIFICATIONS, ETC

As described above, embodiments of the present invention have been described; however, the specific configuration is not limited to the above-described embodiments, but includes designs and the like within the scope of the invention. Further, each of the above-described configurations and embodiments can be arbitrarily combined.

[14-1] As explained above, according to the image display system or the display control device of the present embodiment, by dynamically switching the live-action image to be displayed in the overlap area, it is possible to reduce the incongruity of seams (misalignment) between the adjacent live-action images captured by multiple cameras without performing a stitching process. Therefore, it is also possible to use the live-action image (live video) captured in real time by the camera that images the real space as it is and to display the live-action image on the HMD 10 as a VR image.

For example, it may be configured such that the camera 200 illustrated in FIG. 26 is connected to the display control device 20 by wire or wireless, and the live video captured by the camera 200 is displayed on the HMD 10 as a VR image. Further, the camera 200 and the display control device 20 may be connected to data communication via a network such as the internet, etc. In this case, a live video of a remote location captured by the camera 200 may be displayed on the HMD 10 as a VR image. Further, a server having a function of Video Streaming Service may be set on the network, to distribute a live video captured by the camera 200 via the server over the network. In this case, it can be configured such that the display control device 20 receives the live video at a remote location distributed over the network, and to display the live image as a VR image on the HMD 10 almost in real time.

That is, the system that displays a live-action image including a close-range image on the HMD as a VR image can be realized by an image display system including a plurality of cameras having different imaging directions for imaging a real space, a display control device having the aforementioned configuration, and an HMD, or an image display system including the above plurality of cameras, a distribution server, a display control device having the aforementioned configuration, and an HMD.

[14-2]

In the above, the display control for displaying a VR image of a field of vision from a virtual viewpoint in the VR space on the display unit 11 of the HMD 10 as a stereoscopic image using binocular parallax has been described. However, it can also be applied to the display control of non-stereoscopic images that do not use binocular parallax, i.e., two-dimensional (2D) images. That is, when binocular parallax is used, all or part of each of the above processes is performed for each of the right eye image and the left eye image. In the case of the 2D image, all or part of each of the above processes is performed on the image common to the right eye and the left eye. There is no difference in the processing itself between the stereoscopic image (the image for the right eye or the image for the left eye) and the non-stereoscopic image (common image for the left eye and the right eye), and each of the above configurations can be applied to the display control of the non-stereoscopic image as it is.

That is, each of the above configurations can be applied to the display control device which executes a control of displaying as a stereoscopic image or a non-stereoscopic image, a VR image (a 3D image or a 2D image) of a field of vision from a virtual viewpoint in a VR space on the display unit of the HMD. Conventionally, in the case of either a 3D image or a 2D image, when a plurality of live-action images of the real space captured by a plurality of cameras are combined to create a wide-viewing angle image (video or still image), generated is a single image data completed by the stitching process. In contrast, according to the present embodiment, regardless of with or without stereoscopic vision, a display control is performed such that a plurality of live-action images are arranged in the VR space so that an overlap area occurs in which the viewing regions of the adjacent live-action images partially overlap each other, and based on the viewing direction, a live-action image to be displayed in the overlap area is dynamically switched between the adjacent live-action images. With this configuration, it is possible to reduce the incongruity of seams (misalignment) between the adjacent live-action images captured by multiple cameras without performing a stitching process.

[14-3]

In the above, the display control for displaying an image on the display unit of the HMD has been described. However, the present embodiment can be applied also to the display control for displaying an image on the display unit other than the HMD. For example, the following will explain the case where a high-viewing angle live-action image is displayed on a display unit such as a normal display that is not attached to a user's head or the like.

When displaying a high viewing angle image (for example, an image with a viewing angle of 360 degrees) on the display unit using a plurality of live-action images in the real space, captured by a plurality of cameras, a user views the image while changing the range of the image displayed on the display unit using a mouse, other pointing device, etc. Alternatively, when the display unit is a touch panel or the like having a touch interface, a user views a high viewing image while changing the range of the image displayed on the display unit by a touch operation with a finger, a stylus pen, or the like. Alternatively, a hand tracking system that images a user by a camera and analyzes the movement of his/her hand may be used, and the image may be viewed while changing the range of the image displayed on the display unit with a gesture with user's hands.

In this case, it is determined that a user's viewpoint or a user's line of sight is located at the center of the current image range (the center of the screen) displayed on the display unit, and the viewing direction is specified. Alternatively, for example, a detection information related to the user's line of sight may be obtained by an eye tracking system of the display unit or the like, and the viewing direction may be specified based on the detection information.

As described, in the case of displaying a high viewing angle image on the display unit other than the HMD, using a plurality of live-action images captured by a plurality of cameras having different imaging directions of the real space, the display control may be performed as follows. Namely, the plurality of live-action images are arranged in the VR space so that an overlap area occurs in which the viewing regions of the adjacent live-action images partially overlap each other, and based on the viewing direction, a live-action image to be displayed in the overlap area is dynamically switched between the adjacent live-action images. With this display control, even in the case of the display unit other than HMD, it is possible to realize the display control of reducing the discomfort of seams (misalignment) between the live-action images without performing the stitching process.

Here, a high viewing angle image displayed on the display unit other than the HMD can be a stereoscopic image using binocular parallax or a non-stereoscopic image. When displaying a stereoscopic image, the image for the right eye and the image for the left eye are displayed on the display unit capable of naked-eye stereoscopic vision. Alternatively, provided that dedicated glasses (dedicated glasses of a frame sequential type or a polarization type, etc.), an image for the right eye and an image for the left eye are displayed alternately on the display unit.

[14-4]

As illustrated in the example of FIG. 1, in the case where both of the HMD 10 and the display control device 20 have the configuration and the function as the information processing unit (computer) equipped with the processor and the storage device, some of the functions of the control unit 30 described above may be realized by the processor 13 of the HMD 10 that executes the program according to the present embodiment, while the rest of the functions of the control unit 30 may be realized by the processor 21 of the display control device 20 that executes the program according to the present embodiment.

FIG. 35 is a schematic block diagram illustrating an example of the configuration of a stand-alone HMD 60 in which the function of the display control device 20 is integrated with the HMD 10, or an information processing apparatus 52 such as a smartphone used as the HMD 50 illustrated in the example of FIG. 34. The HMD 60 or the information processing apparatus 52 includes a display unit 61, a sensor 62, a processor 63, a storage device 64, an operation unit 65, a communication unit 66, etc. The display unit 61, the sensor 62, the processor 63, the storage device 64, the operation unit 65, and the communication unit 66 have the same configuration as the display unit 11, the sensor 12, the processor 21, the storage device 22, the operation unit 23, and the communication unit 24, respectively, and the descriptions thereof are omitted. The operation unit 65 or the communication unit 66 may be configured separately as an external unit, or the like, or may be omitted. In the case of the stand-alone HMD 60 or the information processing apparatus 52, it has the configuration and the functions as the information processing unit (computer) equipped with the processor and the storage device, and the described respective functions of the control unit 30 are realized by the processor 63 that executes the program according to the present embodiment.

[14-5]

A part or all of the functions of the control unit 30 described above may be realized by an integrated circuit such as LSI (Large Scale Integration), etc. Further, it may be configured that each of the above functions is integrated into a processor individually.

Alternatively, some or all of the above-described functions may be integrated into a processor.

[14-6]

The computer readable program of the present embodiment is stored in various types of computer-readable recording medium such as a hard disk, an optical disk (CD-ROM, DVD-ROM, etc.), a flexible disk, a semiconductor memory, or the like. The program is read out from the recording medium and executed by a computer constituting the image display system 1 or the display control device 20. Further, a program can be provided to the computer via a network including a communication line such as the Internet, WAN, LAN, or a dedicated line. A program stored in a file server (online storage) may be read out by a computer. Further, a computer may receive a program delivered from a distribution server. The recording medium also includes a recording medium provided in or outside the distribution server, accessible from the distribution server for distributing a program. A program code stored on the recording medium of the distribution server may not be in a code form that can be directly executed on the computer that received the program. Namely, as long as the program is executable by the computer after the download from the distribution server, the format of the program stored in the recording medium of the distribution server is arbitrary. Further, the program may be divided when downloading, and a plurality of divided programs may be merged after being downloaded respectively at different timings. Further, the distribution server that distributes each of the divided programs may not be the same. Further, the computer-readable recording medium includes those temporarily hold a program, such as a volatile memory like a RAM in a server that transmits a program via a network or a computer that receives it. Further, the program may be a differential program that can realize the above-described function in combination with a program already stored on the computer.

### 15. APPENDIXES

From the above description, the present invention can be understood, for example, as follows. In order to clarify each aspect, reference numerals in the drawings are appended below in parentheses for convenience. However, the present invention is not limited to the drawings.

1) A program according to one aspect of the present invention causes a computer, which performs a control for displaying a VR image of a field of vision from a virtual viewpoint (P) in a virtual reality (VR) space (V) as a stereoscopic image using binocular parallax on a display unit (11) of a head mount display, to function as a viewing direction specifying unit (31) specifying a viewing direction(S) as a direction of a user's line of sight for the VR space, and an image generation unit (32) generating the VR image according to the viewing direction by arranging in the VR space, a plurality of live-action images captured by a plurality of cameras having different imaging directions, which image a real space so as to have an overlap area (A) in which the respective viewing regions (A1, A2) of the adjacent live-action images partially overlap with each other, wherein the image generation unit (32) dynamically switches based on the viewing direction, the live-action image to be displayed in the overlap area between the adjacent live-action images.

Here, the “computer” may include at least a processor and a storage device (memory). Examples of the computer capable of display control of the VR image include a stationary or portable game machine, a business use (commercial use) game machine, a personal computer, a tablet computer, a smartphone, a mobile phone terminal, a PHS terminal, a PDA, a multifunctional television receiver with an information processing function, and the like. Other than the above, any device including a processor and a memory device is included in the examples of the “computer”. Additionally, the HMD itself including the processor and the memory is included in the examples of the “computer”. As illustrated in FIG. 34, in the case of the HMD 50 including the attachment 51 and the information processing apparatus 52, the information processing apparatus 52 such as a smartphone is included in examples of the “computer”. In addition, a stand-alone HMD is also included in the examples of the “computer”.

2) According to one aspect of the present invention, in the above aspect 1), the image generation unit (32) sets a reference direction (RD, RD1, RD2) in a predetermined direction from the virtual view point (P), and based on the viewing direction(S) with respect to the reference direction, specifies the live-action image to be displayed in the overlap area (AO).

3) According to one aspect of the present invention, in the above aspect 2), the image generation unit (32) sets the reference direction (RD, RD1, RD2) in a direction from the virtual view point (P) to a predetermined position in the overlap area (AO).

4) According to one aspect of the present invention, in the above aspect 2) or 3), the image generation unit (32) changes the reference direction (RD1, RD2) according to the live-action image to be displayed in the overlap area (AO) at a timing of switching the live-action image displayed in the overlap area (AO).)

5) According to one aspect of the present invention, in any of the above aspects 1) to 4), the viewing direction specifying unit (31) obtains a detection information (for example, a detection information of an angular velocity sensor) on an orientation of the head mounted display (10), and specifies the viewing direction(S) based on the detection information.

6) According to one aspect of the present invention, in any of the above aspects 1) to 4), the viewing direction specifying unit (31) obtains a detection information (for example, a detection information of eye tracking) on the user's line of sight, and specifies the viewing direction(S) based on the detection information.

7) According to one aspect of the present invention, in any of the above aspects 1) to 6), the program causes the computer to function as a boundary line display unit (33) displaying a boundary line (BL1, BL2) visible to the user in the boundary region (BD1, BD2) of the adjacent live-action images.

8. According to one aspect of the present invention, in the above aspect 7) the boundary line display unit (33) displays an additional information (GD1, GD2) indicating on which side of the boundary line, the overlap area (AO) exists on or in a vicinity of the boundary line (BL1, BL2).

9) According to one aspect of the present invention, in any of the above aspects 1) to 8), when switching the live-action image to be displayed in the overlap area (AO), the image generation unit (32) gradually switches the live-action image to be displayed in the overlap area (AO) from one to the other of the live-action images as time passes.

10) According to one aspect of the present invention, in the above aspect 9), when switching the live-action image to be displayed in the overlap area (AO), while moving the boundary line (BL1, BL2) to a display position after being switched, the image generation unit (32) gradually switches the live-action image to be displayed in the overlap area (AO) from one to the other of the live-action images as time passes.

11) According to one aspect of the present invention, in any of the above aspects 1) to 10), after determining that a switching process of switching the live-action image to be displayed in the overlap area (OA) is to be performed based on the viewing direction(S), the image generation unit (32) sets a predetermined waiting period before starting the switching process.

12) According to one aspect of the present invention, in any of the above aspects 1) to 11), the image generation unit (32) changes an arrangement of the plurality of live-action images in the VR space (V) while performing a display control of displaying the VR image on the display unit.

13) According to one aspect of the present invention, in any of the above aspects 1) to 11), causes the computer to function as an imaging direction specifying unit (34) specifying a change in the imaging directions of the plurality of cameras which capture the plurality of live-action images, wherein the image generation unit (32) changes direction of an entire viewing region of the plurality of live-action images to be arranged in the VR space (V) according to the change in the imaging direction specified by the imaging direction specifying section.

14. According to one aspect of the present invention, in any of the above aspects 1) to 13), the image generation unit (32) dynamically changes the live-action image to be displayed in the overlap area (AO) between the adjacent live-action images based on the viewing direction(S) so that the region boundary (A1, A2) of the adjacent live-action images is moved away from the viewing direction.

15) According to one aspect of the present invention, in any of the above aspects 1) to 14), the image generation unit (32) obtains a detection information on the orientation of the head mounted display (10), and changes a range of the VR image to be displayed on the display unit (11) based on the detection information.

16) According to one aspect of the present invention, in any of the above aspects 1), 5) to 14), the image generation unit (32) specifies a live-action image to be displayed in the overlap area (AO) based on the viewing direction(S) with respect to a current region boundary (BD1, BD2) of the adjacent live-action images.

17) According to one aspect of the present invention, in the above aspect 15), the image generation unit (32) switches the live-action image currently displayed in the overlap area (AO) to the other live-action image when the viewing direction(S) is moved closer to the current region boundary (BD1, BD2) of the adjacent live-action images by a predetermined distance or closer (for example, an angle formed by the viewing direction and the current region boundary is not more than a predetermined degrees).

18) According to one aspect of the present invention, in the above aspect 8), the additional information is superimposed on the live-action image near the boundary line (BL1, BL2), and includes a translucent gradient part (GD1, GD2) in which a color density or an opacity is reduced gradually or stepwise as being away from the boundary line.

19) According to one aspect of the present invention, in any of the above aspects 7) to 10), the boundary line display unit (33) differs a display pattern of the boundary line (BL1 or BL2) displayed on the region boundary (BD1 or BD2) at one end of the overlap area (AO) from a display pattern of the boundary line displayed on the region boundary at the other end of the overlap area (AO).

20) A display control apparatus (20) according to one aspect of the present invention, which performs a control for displaying a VR image of a field of vison from a virtual viewpoint in a virtual reality (VR) space (V) as a stereoscopic image using binocular parallax on a display unit (11) of a head mount display, includes a viewing direction specifying unit (31) specifying a viewing direction(S) as a direction of a user's line of sight for the VR space, and an image generation unit (32) generating the VR image according to the viewing direction by arranging in the VR space, a plurality of live-action images captured by a plurality of cameras having different imaging directions of a real space so as to have an overlap area (A) in which the respective viewing regions (A1, A2) of the adjacent live-action images partially overlap with each other, wherein the viewing direction specifying unit (31) dynamically switches based on the viewing direction, the live-action image to be displayed in the overlap area between the adjacent live-action images.

21) A image display system (1) according to one aspect of the present invention includes a head mounted display (10) displaying as a stereoscopic image using binocular parallax, a VR image of a field of vision from a virtual viewpoint in a virtual reality (VR) space (V) on a display unit (11); and a display control apparatus (20) executing a control for displaying the VR image on the display unit (11), wherein the display control apparatus (20) includes a viewing direction specifying unit (31) specifying a viewing direction(S) as a direction of a user's line of sight for the VR space, and an image generation unit (32) generating the VR image according to the viewing direction by arranging in the VR space, a plurality of live-action images captured by a plurality of cameras having different imaging directions, which image a real space so as to have an overlap area (A) in which the respective viewing regions (A1, A2) of the adjacent live-action images partially overlap with each other, wherein the image generation unit (32) dynamically switches based on the viewing direction, the live-action image to be displayed in the overlap area between the adjacent live-action images.

22) An information storage medium according to one aspect of the present invention is a non-transitory computer readable storage medium storing the program in any of the above aspects 1) to 19).

23) A control method of the display control apparatus (22) according to one aspect of the present invention, causes the display control apparatus (22) to display as a stereoscopic image to which binocular parallax is applied, a VR image of a field of vision from a virtual viewpoint in a virtual reality (VR) space (V) on the display unit (11) of the head mount display includes: a viewing direction specifying step (S106) of specifying a viewing direction(S) as a direction of a user's line of sight for the VR space; arranging (S102) in the VR space, a plurality of live-action images captured by a plurality of cameras having different imaging directions, which image the real space so as to have an overlap area (A) in which the respective viewing regions (A1, A2) of the adjacent live-action images partially overlap with each other; and an image generation step (S108 to S114) of generating the VR image according to the viewing direction, wherein the image generation step includes the step of dynamically switching based on the viewing direction, the live-action image to be displayed in the overlap area between the adjacent live-action images.

Note that the embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

### DESCRIPTION OF REFERENCE SIGNS

1 . . . image display system
10 . . . . Head Mounted Display
11, 61 . . . display
12, 62 . . . sensor
13 . . . processor
14 . . . storage device
20 . . . display control apparatus
21,63 . . . processor
22, 64 . . . storage device
23, 65 . . . operation unit
24, 66 . . . communication unit
30 . . . control unit
31 . . . viewing direction specifying unit
32 . . . image generation unit
321 . . . image arrangement unit
322 . . . switch unit
33 . . . boundary line display unit
34 . . . imaging direction specifying unit
60 . . . . Head Mounted Display (an example of an information processing unit)
200 . . . camera
A1, A2 . . . viewing region
AO . . . overlap area
RD . . . reference direction
V . . . VR space
S . . . viewing direction
BL1, BL2 . . . boundary line
GD1, GD2 . . . gradation part

What is claimed is:

1. A non-transitory computer-readable storage medium having recorded therein a program that is executed by a processor of an information processing apparatus, the program causes the processor to:
display as a stereoscopic image to which binocular parallax is applied, a VR image of a field of vision from a virtual viewpoint in a virtual reality (VR) space on a display unit of a head mount display,
specify a viewing direction as a direction of a user's line of sight for the VR space;
arrange in the VR space, a plurality of live-action images captured by a plurality of cameras respectively having different imaging directions of imaging a real space, so as to have an overlap area in which viewing regions of adjacent live-action images are partially overlapped with each other;
generate the VR image according to the viewing direction; and
dynamically switch based on the viewing direction the live-action image to be displayed in the overlap area between the adjacent live-action images.

2. The storage medium of claim 1, wherein the program causes the processor to:
set a reference direction in a predetermined direction from the virtual view point; and
specify the live-action image to be displayed in the overlap area based on the viewing direction with respect to the reference direction.

3. The storage medium of claim 2, wherein the program causes the processor to:
set the reference direction in a direction from the virtual view point to a predetermined position in the overlap area.

4. The storage medium of claim 2, wherein the program causes the processor to:
change the reference direction according to the live-action image to be displayed in the overlap area at a timing of switching the live-action image displayed in the overlap area.

5. The storage medium of claim 1, wherein the program causes the processor to:
obtain a detection information on an orientation of the head mounted display, and specify the viewing direction based on the detection information.

6. The storage medium of claim 1, wherein the program causes the processor to:
obtain a detection information on a user's line of sight, and specify the viewing direction based on the detection information.

7. The storage medium of claim 1, wherein the program causes the processor to:
display a boundary line visible to the user on the boundary region of the adjacent live-action images.

8. The storage medium of claim 7, wherein the program causes the processor to:
display an additional information indicating on which side of the boundary line is the overlap area on or in a vicinity of the boundary line.

9. The storage medium of claim 7, wherein the program causes the processor to:
gradually switch the live-action image to be displayed in the overlap area from one to the other of the live-action images as time passes when switching the live-action image to be displayed in the overlap area.

10. The storage medium of claim 9, wherein the program causes the processor to:
gradually switch the live-action image to be displayed in the overlap area from one to the other of the live-action images as time passes when switching the live-action image to be displayed in the overlap area, while gradually moving the boundary line to a display position after being switched.

11. The storage medium of claim 1, wherein the program causes the processor to:
set a predetermined waiting period before starting the switching process after determining that a switching process of switching the live-action image to be displayed in the overlap area is to be performed.

12. The storage medium of claim 1, wherein the program causes the processor to:
change an arrangement of the plurality of live-action images in the VR space while performing a display control of displaying the VR image on the display unit.

13. The storage medium of claim 1, wherein the program causes the processor to:
specify a change in the imaging directions of the plurality of cameras which capture the plurality of live-action images; and
change a direction of an entire viewing region of the plurality of live-action images to be arranged in the VR space according to the change in the imaging directions.

14. A display control apparatus comprising a processor, and a memory storing instructions executable by the processor, that, when executed by the processor, cause the processor to:
display as a stereoscopic image to which binocular parallax is applied, a VR image of a field of vision from a virtual viewpoint in a virtual reality (VR) space on a display unit of a head mount display,
specify a viewing direction as a direction of a user's line of sight for the VR space;
arrange in the VR space, a plurality of live-action images captured by a plurality of cameras respectively having different imaging directions of imaging a real space, so as to have an overlap area in which viewing regions of adjacent live-action images are partially overlapped with each other;
generate the VR image according to the viewing direction; and
dynamically switch based on the viewing direction the live-action image to be displayed in the overlap area between the adjacent live-action images.

15. A display control method comprising:
displaying as a stereoscopic image to which binocular parallax is applied, a VR image of a field of vision from a virtual viewpoint in a virtual reality (VR) space on a display unit of a head mount display;
specifying a viewing direction as a direction of a user's line of sight for the VR space;
arranging in the VR space, a plurality of live-action images captured by a plurality of cameras respectively having different imaging directions of imaging a real space, so as to have an overlap area in which viewing regions of adjacent live-action images are partially overlapped with each other;
generating the VR image according to the viewing direction; and
dynamically switching based on the viewing direction the live-action image to be displayed in the overlap area between the adjacent live-action images.
